(19) United States
(12) Patent Application Publication
(10) Pub. No.: US 2023/0166411 A1
(43) Pub. Date: Jun. 1, 2023

(54) END EFFECTOR

(71) Applicant: YAMAHA HATSUDOKI KABUSHIKI KAISHA, Iwata-shi (JP)

(72) Inventors: Yoshinori HARADA, Shizuoka (JP); Masashi UENOYAMA, Shizuoka (JP); Wataru ISHII, Shizuoka (JP)

(21) Appl. No.: 18/154,790

(22) Filed: Jan. 13, 2023

Related U.S. Application Data
(63) Continuation-in-part of application No. PCT/JP2021/026466, filed on Jul. 14, 2021.

(30) Foreign Application Priority Data
Jul. 15, 2020 (JP) PCT/JP2020/027537

(51) Int. Cl. B25J 15/10; B25J 9/16

(52) U.S. Cl. CPC B25J 15/10; B25J 9/1697; B25J 9/1664

(57) ABSTRACT

An end effector including a processing mechanism and a target-object-positioning mechanism provided at a support member. The target-object-positioning mechanism includes a first contact-and-move member configured to move in a front-rear direction of the end effector and in a first orthogonal direction with respect to the support member, and a second contact-and-move member configured to move in the front-rear direction and in a second orthogonal direction with respect to the support member. The first and second contact-and-move members, while maintaining a position thereof in the front-rear direction with respect to the support member, move in the first orthogonal direction and the second orthogonal direction, respectively, to make contact with the target object in a contact-and-move-member-moving space. The first and second contact-and-move members, while maintaining contact with the target object, move in a rearward direction with respect to the support member, to thereby position the target object at a processing position.

### CROSS-REFERENCES TO RELATED APPLICATIONS

The present application is a continuation-in-part application of International Application No. PCT/JP2021/026466, filed on Jul. 14, 2021, and having the benefit of the earlier filing date of International Application No. PCT/JP2020/027537, filed on Jul. 15, 2020. The content of each of the identified applications is incorporated herein by reference in its entirety.

### TECHNICAL FIELD

The present teaching relates to an end effector.

### BACKGROUND ART

Fruits such as strawberries and grapes, and green and yellow vegetables such as asparagus and tomatoes, are delicate and prone to damage as well as have high unit prices, compared with grain such as wheat. Such delicate crops with high unit prices are harvested manually one by one to prevent damage caused to the crops at the time of harvest. Therefore, harvesting, e.g., fruits and green and yellow vegetables, places a large physical burden on a producer, as compared with, e.g., grain that can be harvested efficiently on a large scale by using harvesting machines such as combine harvesters. The harvesting operation, due to its large physical burden, involves difficulty in securing labor force, and therefore tends to place an increased burden on a producer. Thus, crop harvesting systems using a multi joint robot arm are known. The crop harvesting systems are provided with, e.g., a working device and an image processor for harvesting crops at the end of the multi-joint robot arm. The harvesting systems locate the position of a crop to be harvested by the image processor, and perform a harvesting operation by the working device.

For example, Patent Document 1 discloses a robotic harvesting system provided with a picking head (end effector) for harvesting a crop at the end of a multi-joint robot arm. The end effector described in Patent Document 1 has a hook for grabbing a crop to be harvested, a gripper for gripping the crop, a cutter for cutting off the crop, and a camera for identifying the crop. When harvesting a crop, the robotic harvesting system identifies the crop to be harvested based on an image taken by the camera. Subsequently, the robotic harvesting system moves the hook along a predetermined circular arc by the multi joint robot arm to allow the hook to grab a stem of the crop to be harvested. The stem contacted by a rod-shaped part of the hook is grabbed by a semicircular-shaped end portion of the hook through the movement of the hook along the circular-arc trajectory. The robotic harvesting system cuts the stem grabbed by the hook using the cutter, as well as grips the crop by the gripper.

### CITATION LIST

### Patent Document

Patent Document 1: International Patent Application Publication No. 2018/087546

### SUMMARY OF INVENTION

### Technical Problem

In such robotic harvesting systems, it is required to make a part for grabbing a crop as compact as possible to suppress interference of an end effector with, e.g., crops around a crop to be harvested. The robotic harvesting system described in Patent Document 1 is configured to cause the hook that has the rod-shaped member with its end portion being semicircular shaped to grab the crop to be harvested. That is, the robotic harvesting system uses the hook having the semicircular-shaped end portion into which the function of grabbing the crop to be harvested is consolidated, to thereby suppress interference with crops around the crop to be harvested.

In order to move the hook along the circular-arc trajectory, the robotic harvesting system causes respective axes of the multi-joint robot arm that is a work machine for moving the end effector to operate in conjunction with each other with high precision. When the crop to be harvested slightly moves due to external factors such as wind and rain, the robotic harvesting system causes the respective axes of the multi-joint robot arm to operate in conjunction with each other with still higher precision, thereby increasing the rate of grabbing the crop to be harvested. Thus, in the robotic harvesting system, the precision of the multi-joint robot arm in moving the end effector affects the rate of grabbing a crop by the end effector. That is, in order to grab the crop to be harvested even when a condition of a surrounding environment changes, the robotic harvesting system needs to detect changes in environment with high precision and to move the end effector by the multi joint robot arm with high precision.

The robotic harvesting system moves the entirety of the end effector including the hook along the circular-arc trajectory to grab the crop to be harvested. That is, in the robotic harvesting system, there exists a moving space that the entirety of the end effector passes across, around the crop to be harvested. Therefore, the robotic harvesting system has a possibility that the end effector makes contact with, e.g., crops in the moving space and causes damage to, e.g., the crops around the crop to be harvested.

The end effector as described above is required to improve robustness such that a target object can be processed even when a condition of a surrounding environment changes, without increasing the moving space of the end effector.

It is an object of the present teaching to provide an end effector that can suppress interference with objects around a target object, while reducing the time required to move the end effector and the energy required to move the end effector, without highly precisely moving a work machine that moves the end effector.

### Solution to Problem

The inventors of the present teaching studied an end effector that can suppress interference with objects around a target object, while reducing the time required to move the end effector and the energy required to move the end effector, without highly precisely moving a work machine that moves the end effector. Through an intensive study, the inventors arrived at the configuration as described below.

An end effector according to one embodiment of the present teaching is configured to be movable by a work machine, for processing a target object at a processing position of the end effector, and includes: a support member configured to be supported by the work machine; a processing mechanism provided in the support member, for processing a portion of the target object at the processing position; and a target-object-positioning mechanism provided at the support member, the target-object-positioning mechanism including a plurality of contact-and-move members configured to position the portion of the target object at the processing position.

The plurality of contact-and-move members includes: a first contact-and-move member configured to move in a front-rear direction of the end effector, and in a first orthogonal direction with respect to the support member, the front-rear direction including a forward direction from the support member toward the processing position of the end effector, and a rearward direction opposite to the forward direction, the first orthogonal direction being orthogonal to the front-rear direction, and a second contact-and-move member configured to move in the front-rear direction, and in a second orthogonal direction with respect to the support member, the second orthogonal direction being orthogonal to the front-rear direction and being different from the first orthogonal direction, to thereby define a contact-and-move-member-moving space in which the plurality of contact-and-move members are movable and of which a cross-sectional area perpendicular to the front-rear direction increases in the forward direction.

The first contact-and-move member is configured to, while maintaining a position thereof in the front-rear direction with respect to the support member, move in the first orthogonal direction, to make contact with the target object in the contact-and-move-member-moving space. The second contact-and-move member is configured to, while maintaining a position thereof in the front-rear direction with respect to the support member, move in the second orthogonal direction, to make contact with the target object in the contact-and-move-member-moving space. The first contact-and-move member and the second contact-and-move member are further configured to, while maintaining contact with the target object, move in the rearward direction with respect to the support member, to thereby position the portion of the target object at the processing position.

As described above, the end effector grabs the target object present in the contact-and-move-member-moving space by at least the first contact-and-move member and the second contact-and-move member, while maintaining the positions of these members in the front-rear direction with respect to the support member. Subsequently, the end effector moves the first contact-and-move member and the second contact-and-move member in the rearward direction with respect to the support member with the target object grabbed by these contact-and-move members, and positions the processing portion of the target object at the processing position. That is, at the time of grabbing the target object present in the contact-and-move-member-moving space, the end effector grabs the target object without drawing it toward the support member. Furthermore, the end effector moves the target object to the processing position in a state where the first contact-and-move member and the second contact-and-move member come the closest to each other.

Therefore, as long as the end effector is moved by the work machine with such precision that the target object is included in the contact-and-move-member-moving space that increases three-dimensionally in directions perpendicular to the front-rear direction, from the processing position to the forward direction, the end effector can grab the target object three-dimensionally from different directions by the first contact-and-move member and the second contact-and-move member. When the target object is present in the contact-and-move-member-moving space, the end effector can grab the target object and position the processing portion of the target object at the processing position by the first contact-and-move member and the second contact-and-move member, without moving the entirety of the end effector by the work machine.

Thus, the end effector can perform processing on the target object even when a condition of a surrounding environment of the target object changes, without increasing a moving space of the end effector. That is, the end effector has increased robustness through the first contact-and-move member and the second contact-and-move member.

The end effector grabs the target object without moving the target object considerably, which is conducive to suppressing interference with objects around the target object at the time of grabbing. Furthermore, the end effector causes the first contact-and-move member and the second contact-and-move member to move the target object with these members in contact with each other, so that interference with objects around the target object can be suppressed when positioning the target object at the processing position.

Thus, the end effector is not required to cause a plurality of actuators operating the work machine to operate in conjunction with each other with high precision to grab the target object. Furthermore, in the end effector, it is not required to move the entirety of the end effector in the vicinity of the target object when the target object is present in the contact-and-move-member-moving space. The end effector causes the first contact-and-move member and the second contact-and-move member to pass through the minimum space as required when grabbing the target object and positioning the target object at the processing position. This allows the end effector to suppress interference with objects around the target object, while reducing the time required to move the end effector and the energy required to move the end effector, without highly precisely moving the work machine that moves the end effector.

In another aspect, the end effector according to the present teaching preferably includes the following configuration. The first contact-and-move member, the second contact-and-move member, and the processing mechanism are operated by a single actuator.

As described above, the end effector does not have actuators, each moving one of the first contact-and-move member, the second contact-and-move member, and the processing mechanism, individually. Thus, the size, weight and moment of inertia of the end effector are small, compared with a case where the end effector has actuators for individual operation of each of the first contact-and-move member, the second contact-and-move member, and the processing mechanism. This allows the end effector to suppress interference with objects around the target object, while reducing the time required to move the end effector and the energy required to move the end effector, without highly precisely moving the work machine that operates the end effector.

In another aspect, the end effector according to the present teaching preferably includes the following configuration. The plurality of contact-and-move members further includes a third contact-and-move member, which is configured to move relative to the first contact-and-move member and the second contact-and-move member, in an approaching direction toward, and in a leaving direction from, the first contact-and-move member and the second contact-and-move member.

As described above, the end effector causes the first contact-and-move member, the second contact-and-move member, and the third contact-and-move member to move three-dimensionally from respective different directions to grab the target object. Therefore, the end effector can grab the target object without moving the body of the end effector even when e.g., shape, position, and posture of the target object change. This allows the end effector to suppress interference with objects around the target object, while reducing the time required to move the end effector and the energy required to move the end effector, without highly precisely moving the work machine that moves the end effector.

In another aspect, the end effector according to the present teaching preferably includes the following configuration. The third contact-and-move member is fixed to the support member, or is movable with respect to the support member in the front-rear direction and in a third orthogonal direction, the third orthogonal direction being another direction orthogonal to the front-rear direction but different from the first orthogonal direction and the second orthogonal direction.

Thus, in the end effector, the third contact-and-move member may be made of a material with sufficiently high rigidity compared with the first contact-and-move member and the second contact-and-move member. The end effector can move the target object present in the contact-and-move-member-moving space toward the third contact-and-move member by the first contact-and-move member and the second contact-and-move member, and grab the target object at the position of the third contact-and-move member. Therefore, the end effector can grab the target object by using the third contact-and-move member as a base for positioning. The end effector can grab the target object present in the contact-and-move-member-moving space, from three directions by the first contact-and-move member, the second contact-and-move member, and the third contact-and-move member. This allows the end effector to suppress interference with objects around the target object, while reducing the time required to move the end effector and the energy required to move the end effector, without highly precisely moving the work machine that moves the end effector.

In another aspect, the end effector according to the present teaching preferably includes the following configuration. The contact-and-move-member-moving space, when viewed in the front-rear direction, overlaps at least partially with the processing position.

As described above, the end effector performs, by the processing mechanism, processing on the target object grabbed by at least the first contact-and-move member and the second contact-and-move member in the contact-and-move-member-moving space. That is, as long as the end effector grabs the target object by at least the first contact-and-move member and the second contact-and-move member, the end effector can move the target object to the processing position. This allows the end effector to suppress interference with objects around the target object, while reducing the time required to move the end effector and the energy required to move the end effector, without highly precisely moving the work machine that moves the end effector.

In another aspect, the end effector according to the present teaching preferably includes the following configuration. The contact-and-move-member-moving space, when viewed in the front-rear direction, overlaps at least partially with the support member.

As described above, the end effector has the three-dimensional contact-and-move-member-moving space around the support member, when viewed in the front-rear direction. That is, the end effector can perform processing on the target object, irrespective of variations in position of the target object with respect to the support member supporting the first contact-and-move member and the second contact-and-move member. This allows the end effector to suppress interference with objects around the target object, while reducing the time required to move the end effector and the energy required to move the end effector, without highly precisely moving the work machine that moves the end effector.

In another aspect, the end effector according to the present teaching preferably includes the following configuration. The first contact-and-move member has an end portion that is bent to be of a claw shape, moves in the front-rear direction with respect to the support member, and moves in the first orthogonal direction with respect to the support member. The second contact-and-move member has an end portion that is bent to be of the claw shape, moves in the front-rear direction with respect to the support member, and moves in the second orthogonal direction with respect to the support member. The third contact-and-move member has an end portion that is bent to be of the claw shape, moves in the front-rear direction with respect to the support member, and moves in a third orthogonal direction with respect to the support member, the third orthogonal direction being another direction orthogonal to the front-rear direction and being different from the first orthogonal direction and the second orthogonal direction. The first contact-and-move member, the second contact-and-move member, and the third contact-and-move member are moved by a single actuator.

As described above, the end effector causes the claw-shaped first contact-and-move member, second contact-and-move member, and third contact-and-move member to move in respective different orthogonal directions to the front-rear direction, thereby to grab the target object three-dimensionally. Therefore, the end effector can grab the target object without moving the body of the end effector, irrespective of variations in, e.g., shape, position, and posture of the target object. This allows the end effector to suppress interference with objects around the target object, while reducing the time required to move the end effector and the energy required to move the end effector, without highly precisely moving the work machine that moves the end effector.

In another aspect, the end effector according to the present teaching preferably includes the following configuration. The end effector further includes an imaging device that is provided on the support member, wherein the plurality of the contact-and-move members operate in an imaging area of the imaging device.

As described above, the end effector can simultaneously capture images of the target object, and at least the first contact-and-move member and the second contact-and-move member, by the imaging device. That is, the end effector can simultaneously obtain information on the processing position of the target object, and information on the contact position at which the first contact-and-move member and the second contact-and-move member make contact with the target object, through the images captured by the imaging device. Therefore, the end effector provides the images captured by the imaging device to a control device of the work machine, so that the end effector is moved by the work machine so as to include the target object in the contact-and-move-member-moving space. This allows the end effector to suppress interference with objects around the target object, while reducing the time required to move the end effector and the energy required to move the end effector, without highly precisely moving the work machine that moves the end effector.

The terminology used herein is for the purpose of describing particular embodiments only and is not intended to be limiting of the invention.

As used herein, the term “and/or” includes any and all combinations of one or more of the associated listed items.

It will be further understood that the terms “including,” “comprising” or “having” and variations thereof when used in this specification specify the presence of stated features, steps, operations, elements, components, and/or their equivalents, but do not preclude the presence or addition of one or more steps, operations, elements, components, and/or groups thereof.

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include electrical connections or couplings, whether direct or indirect.

Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention.

Embodiments of an end effector according to the present teaching will be herein described.

In the following description, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

[End Effector]

An end effector herein refers to a device for performing arbitrary processing on a target object. The end effector is attached to an end of a work machine such as a robot arm. The end effector has a configuration that corresponds to processing performed on the target object, and includes a variety of devices corresponding to the processing.

[Target Object]

A target object herein refers to a target on which the end effector performs processing, such as a natural object, an artifact, a virus, and a living thing (an animal, a plant). The target object specifically refers to, e.g., an agricultural product, a marine product, an industrial product, a domestic animal, an insect, and a human. The target object is an object including both a processing portion that is a portion processed by the end effector, and a contact portion contacted by a contact unit to move the processing portion to a processing position. The target object includes, for example, a peduncle, a fruit, a trunk, a stem, a branch, a leaf, a stalk, and a living thing in an agricultural product.

[Processing]

Processing herein refers to the work performed on the target object by the end effector. The processing includes, for example, physical processing, stimulation, operation, inspection, and detection of the target object, such as grasping, sucking, cutting, heating, cooling, marking, measuring, injecting, and imaging the target object.

[Processing Mechanism]

A processing mechanism herein refers to a mechanism for performing processing on the target object in the end effector. The processing mechanism, for example, performs physical processing, stimulation, operation, inspection, and detection of the target object, such as grasping, sucking, cutting, heating, cooling, marking, measuring, injecting, and imaging the target object. The processing mechanism includes, for example, a grasping mechanism for grasping the target object, a sucking mechanism for sucking the target object, a cutting mechanism for cutting the target object, a heating-cooling mechanism for heating and cooling the target object, a marking mechanism for marking the target object, and a measuring mechanism for measuring the target object.

[Target-Object-Positioning Mechanism]

A target-object-positioning mechanism herein refers to a mechanism for positioning the target object at the processing position in the end effector. The target-object-positioning mechanism has a function of grabbing the target object at a grabbing position. The target-object-positioning mechanism has a function of moving the grabbed target object from the grabbing position to the processing position. The target-object-positioning mechanism has a function of holding the target object.

[Three-Dimensional-Contact-and-Move Mechanism]

A three-dimensional-contact-and-move mechanism herein refers to a configuration constituted by a plurality of contact-and-move members for making contact with the target object in the target-object-positioning mechanism. The three-dimensional-contact-and-move mechanism moves each of the contact-and-move members in each different orthogonal direction to a front-rear direction of the end effector. The three-dimensional-contact-and-move mechanism disposes the contact-and-move members such that the contact-and-move members can move three-dimensionally within their moving range, thereby enlarging a region in which to grab the target object, from a two-dimensional region to a three-dimensional region.

[Processing Portion]

A processing portion herein refers to a portion of the target object on which the processing mechanism performs the processing. There are both a case where the processing portion is different from a contact portion contacted by the contact-and-move members of the target-object-positioning mechanism, and a case where the processing portion includes a part of the contact portion.

[Processing Position]

A processing position herein refers to a position within the end effector at which the processing mechanism performs the processing on the target object in the end effector. The processing position is included in at least a part of a contact-and-move-member-moving space included in the end effector.

[Work Machine]

A work machine herein refers to a machine for moving the end effector to a predetermined position to allow the end effector to perform the processing on the target object. A machine capable of moving the end effector suffices as the work machine, such as a robot arm, an unmanned flight vehicle, and an unmanned ground vehicle.

### Advantageous Effects of Invention

According to one embodiment of the present teaching, it is possible to suppress interference of the end effector with objects around the target object, while reducing the time required to move the end effector and the energy required to move the end effector, without highly precisely moving the work machine that moves the end effector.

### BRIEF DESCRIPTION OF DRAWINGS

FIG. 1 is a perspective view of an end effector according to a first embodiment of the present teaching.

FIG. 2A is a cross-sectional view of the end effector that is viewed in a direction of arrow A in FIG. 1.

FIG. 2B is a cross-sectional view of the end effector that is viewed in a direction of arrow B in FIG. 2A.

FIG. 3 is a front view of contact-and-move members of the end effector according to the first embodiment of the present teaching.

FIG. 4 is a cross-sectional view of the end effector according to the first embodiment of the present teaching that is viewed in the direction of arrow B in FIG. 2A, when a target-object-positioning mechanism of the end effector has grabbed a target object at a grabbing position.

FIG. 5 is a cross-sectional view of the end effector according to the first embodiment of the present teaching that is viewed in the direction of arrow B in FIG. 2A, when the target-object-positioning mechanism of the end effector has moved the target object to a processing position.

FIG. 6 is a cross-sectional view of the end effector according to the first embodiment of the present teaching that is viewed in a direction of arrow C in FIG. 2A, and a cross-sectional view of the end effector that is viewed in the direction of arrow A in FIG. 1, when a processing mechanism of the end effector has positioned the target object at the grabbing position.

FIG. 7 is a cross-sectional view of the end effector according to the first embodiment of the present teaching that is viewed in the direction of arrow C in FIG. 2A, and a cross-sectional view of the end effector that is viewed in the direction of arrow A in FIG. 1, when the processing mechanism of the end effector has moved to the processing position.

FIG. 8 is a cross-sectional view of the end effector according to the first embodiment of the present teaching that is viewed in the direction of arrow C in FIG. 2A, and a cross-sectional view of the end effector that is viewed in the direction of arrow A in FIG. 1, when the target-object-positioning mechanism and the processing mechanism have moved to the grabbing position.

FIG. 9 is a perspective view of a contact-and-move-member-moving space and a front view of the contact-and-move members in the end effector according to the first embodiment of the present teaching.

FIG. 10 is a cross-sectional view of an end effector according to a second embodiment of the present teaching that is viewed in the direction of arrow A in FIG. 1, and a front view of contact-and-move members.

FIG. 11 is a plan view and a cross-sectional side view that show an imaging area of an imaging device in an end effector according to a third embodiment of the present teaching.

FIG. 12 is front views of contact-and-move members of an end effector according to another embodiment of the present teaching.

FIG. 13 is a cross-sectional view of the end effector according to the first embodiment of the present teaching that is viewed in the direction of arrow C in FIG. 2A when the processing mechanism of the end effector has positioned the target object at the grabbing position, a cross-sectional view of the end effector that is viewed in the direction of arrow C in FIG. 2A when the target-object-positioning mechanism and the processing mechanism have moved to the grabbing position, and a cross-sectional view of the end effector that is viewed in the direction of arrow B in FIG. 2A when the target-object-positioning mechanism of the end effector has moved the target object to the processing position.

### DESCRIPTION OF EMBODIMENT

Embodiments will be described hereinafter with reference to the drawings. In the drawings, the same or corresponding parts are denoted by the same reference numerals, and description thereof will not be repeated. The dimensions of components in the drawings do not strictly represent, e.g., actual dimensions of the components and dimensional proportions of the components.

### First Embodiment

<Overall Configuration>

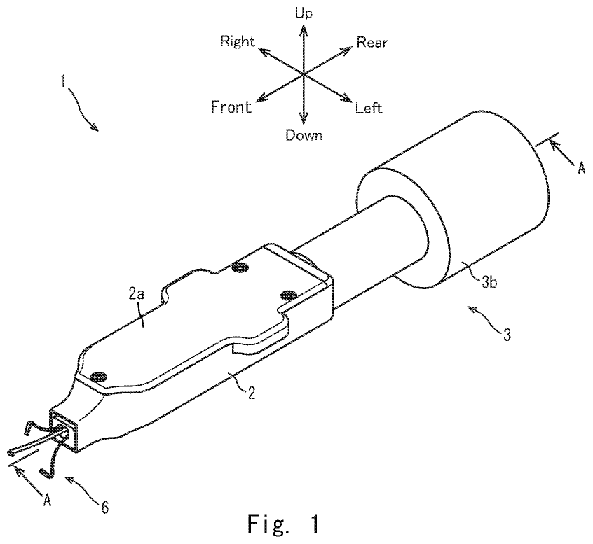

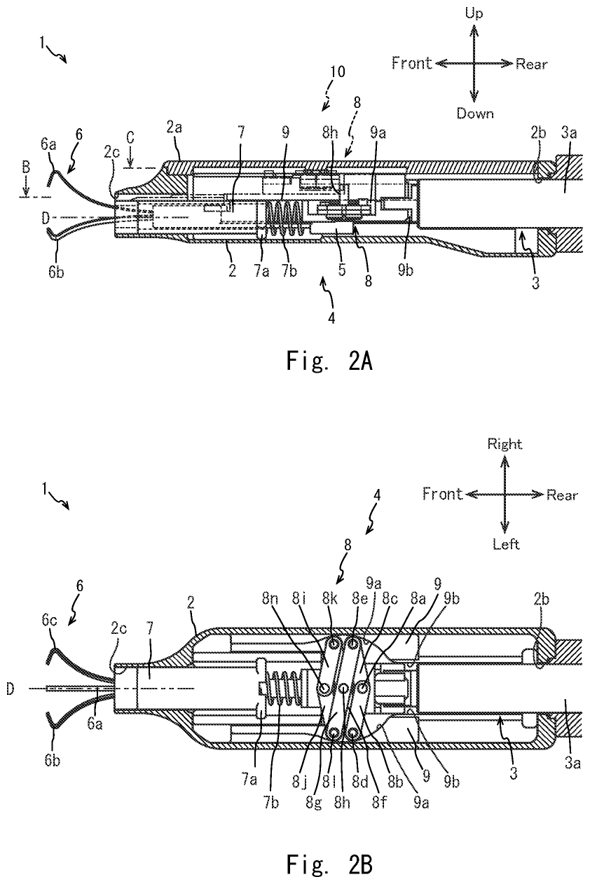

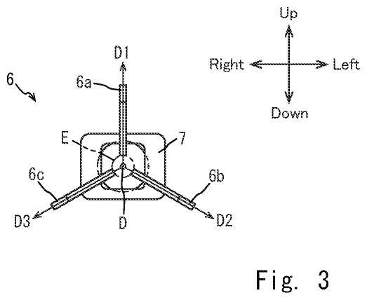

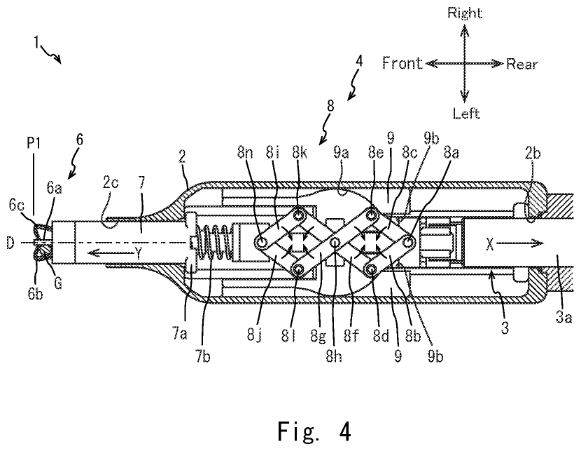

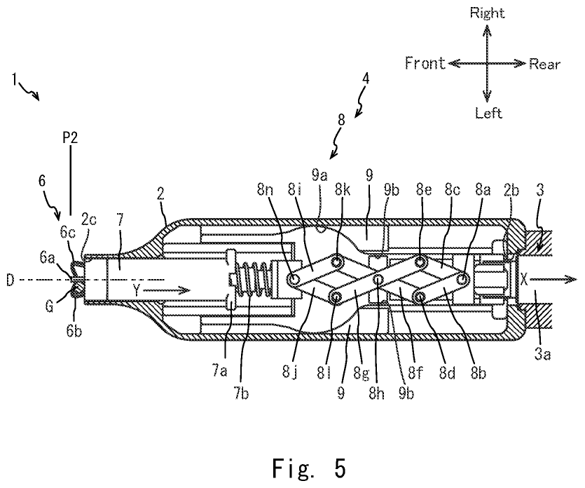

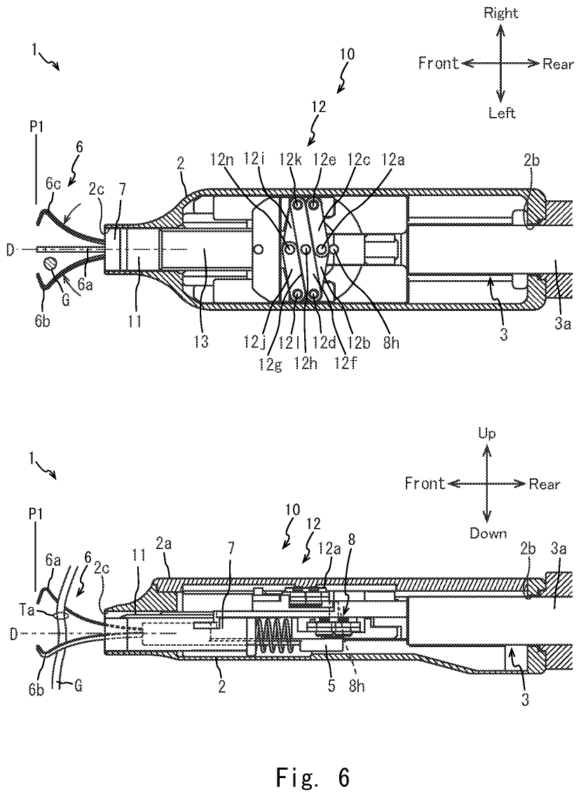

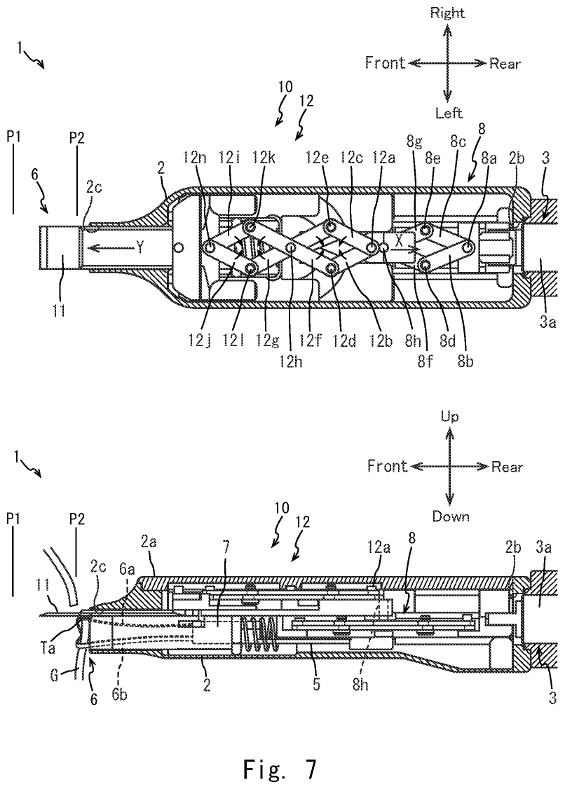

An end effector 1 according to a first embodiment of the present teaching will be described with reference to FIGS. 1 to 7. FIG. 1 is a perspective view of the end effector 1. FIG. 2A is a cross-sectional view of the end effector 1 that is viewed in a direction of arrow A in FIG. 1. FIG. 2B is a cross-sectional view of the end effector that is viewed in a direction of arrow B in FIG. 2A. FIG. 3 is a front view of a target-object-positioning mechanism 4 of the end effector 1. FIG. 4 is a cross-sectional view of the end effector 1 that is viewed in the direction of arrow B in FIG. 2A, when the target-object-positioning mechanism 4 of the end effector 1 has grabbed a grape stem G at a grabbing position P1. FIG. 5 is a cross-sectional view of the end effector 1 that is viewed in the direction of arrow B in FIG. 2A, when the target-object-positioning mechanism 4 of the end effector 1 has moved the grape stem G to a processing position P2. FIG. 6 is a cross-sectional view of the end effector that is viewed in a direction of arrow C in FIG. 2A, and a cross-sectional view of the end effector that is viewed in the direction of arrow A in FIG. 1, when a processing mechanism 10 of the end effector 1 has positioned the grape stem G at the grabbing position P1. FIG. 7 is a cross-sectional view of the end effector 1 that is viewed in the direction of arrow C in FIG. 2A, and a cross-sectional view of the end effector 1 that is viewed in the direction of arrow A in FIG. 1, when the processing mechanism 10 of the end effector 1 has moved to the processing position P2.

Arrows in the drawings as described below indicate coordinate axis directions in a rectangular coordinate system of the end effector 1. A front-rear direction of the end effector 1 is defined such that a forward direction of the end effector 1 is a direction in which the target-object-positioning mechanism 4 moves toward the grape stem G, or defined as a direction in which a processing blade 11 of the processing mechanism 10 moves toward the processing position P2 from a support member 2. A left-right direction of the end effector 1 is an orthogonal direction to the front-rear direction and an up-down direction of the end effector 1, where the vertical direction is defined as the up-down direction.

As shown in FIG. 1, the end effector 1 is a device for cutting off a bunch of grapes from a grape stem G (see FIG. 4) and harvesting the grapes. In this embodiment, the end effector 1 performs processing for cutting a processing portion Ta in the grape stem G as a target object by the processing mechanism 10. The end effector 1 includes the support member 2, an electric cylinder 3 as an actuator, a three-dimensional-contact-and-move mechanism 6 (a target-object-positioning mechanism 4), and the processing mechanism 10 (see FIG. 2A).

The support member 2 is a component constituting a frame of the end effector 1. The support member 2 is a substantially rectangular parallelepiped casing with one surface opened. The casing constituting the support member 2 is sized to allow the target-object-positioning mechanism 4 and the processing mechanism 10 to be disposed therein. The electric cylinder 3, the target-object-positioning mechanism 4, and the processing mechanism 10 are accommodated inside the support member 2, with a longitudinal direction of the support member 2 lying along the front-rear direction and the opening area being directed upward. A cover 2a is attached to the opening area of the support member 2 so as to close the opening area.

As shown in FIGS. 2A and 2B, a rear surface of the support member 2 is formed with a rod insertion hole 2b into which a piston rod 3a of the electric cylinder 3 is inserted. A front surface of the support member 2 is formed with an opening-and-closing-member-insertion hole 2c into which an opening-and-closing member 7 (see FIG. 4) of the target-object-positioning mechanism 4 and the processing blade 11 of the processing mechanism 10 are inserted. The opening-and-closing-member-insertion hole 2c extends in a tubular shape in the forward direction from the front surface.

The electric cylinder 3 is an actuator for moving the piston rod 3a in an axial direction by an electric motor 3b (see FIG. 1). The electric cylinder 3 has the electric motor 3b, and the piston rod 3a with a threaded portion. The electric motor 3b is configured to allow the piston rod 3a to reciprocate in the axial direction by rotation of a movable core (not shown). The electric cylinder 3 moves the piston rod 3a in the axial direction by the rotation of the movable core. In the electric cylinder 3, a moving direction of the piston rod 3a changes in accordance with a rotation direction of the movable core.

The electric cylinder 3 is fixed to the rear surface of the support member 2. The piston rod 3a of the electric cylinder 3 is inserted into the rod insertion hole 2b of the support member 2. That is, the piston rod 3a of the electric cylinder 3 is configured to be movable in the front-rear direction inside the support member 2. The electric motor 3b of the electric cylinder 3 is configured to be fixable to a work machine that moves the end effector 1. With this configuration, the support member 2 is configured to be supported by the work machine through the electric cylinder 3.

<Target-Object-Positioning Mechanism 4>

The target-object-positioning mechanism 4 is a mechanism for positioning the grape stem G that is a target object. The target-object-positioning mechanism 4 includes a coupling member 5, the three-dimensional-contact-and-move mechanism 6, the tubular opening-and-closing member 7, an extendable link mechanism for opening and closing (opening-and-closing-extendable-link mechanism) 8, and a guide member for opening and closing (opening-and-closing-guide member) 9.

The coupling member 5 is a member for coupling the opening-and-closing member 7 and the opening-and-closing-extendable-link mechanism 8. The coupling member 5 is a rectangular plate-like member. The coupling member 5 is positioned inside the support member 2 such that a longitudinal direction of the coupling member 5 lies along the front-rear direction. The coupling member 5 is configured to be movable in the front-rear direction.

A rear end portion of the coupling member 5 is coupled to an intermediate swing axis for opening and closing (opening-and-closing-intermediate-swing axis) 8h of the opening-and-closing-extendable-link mechanism 8. A front end portion of the coupling member 5 is positioned inside the opening-and-closing member 7. A first contact-and-move member 6a, a second contact-and-move member 6b, and a third contact-and-move member 6c are connected to the front end portion of the coupling member 5.

The three-dimensional-contact-and-move mechanism 6 is a mechanism for grabbing the grape stem G (see FIG. 3). The three-dimensional-contact-and-move mechanism 6 has the first contact-and-move member 6a, the second contact-and-move member 6b, and the third contact-and-move member 6c. The first contact-and-move member 6a, the second contact-and-move member 6b, and the third contact-and-move member 6c are members for grabbing the grape stem G (see FIG. 3). The first contact-and-move member 6a, the second contact-and-move member 6b, and the third contact-and-move member 6c are rectangular plate-like members. The first contact-and-move member 6a, the second contact-and-move member 6b, and the third contact-and-move member 6c are, for example, made of a material that can be easily elastically deformed upon receipt of an external force, such as a leaf spring material and resin. In this embodiment, the first contact-and-move member 6a, the second contact-and-move member 6b, and the third contact-and-move member 6c are made of a rectangular, thin spring leaf material.

As shown in FIGS. 2A, 2B, and 3, rear end portions (base end portions) of the first contact-and-move member 6a, the second contact-and-move member 6b, and the third contact-and-move member 6c are connected to the front end portion of the coupling member 5, such that these contact-and-move members are disposed with their longitudinal directions lying along the front-rear direction. In this state, the rear end portions of the first contact-and-move member 6a, the second contact-and-move member 6b, and the third contact-and-move member 6c are positioned on a reference circle E having an arbitrary radius so as not to overlap each other. The first contact-and-move member 6a is curved such that its front end portion (end portion) is directed in a first orthogonal direction D1 that is orthogonal to a reference line D and is a leaving direction from the reference line D, where the reference line D passes through the center of the reference circle E and extends in the front-rear direction. Likewise, the second contact-and-move member 6b is curved such that its front end portion is directed in a second orthogonal direction D2 that is orthogonal to the reference line D and is a leaving direction from the reference line D. Likewise, the third contact-and-move member 6c is curved such that its front end portion is directed in a third orthogonal direction D3 that is orthogonal to the reference line D and is a leaving direction from the reference line D.

The first orthogonal direction D1, the second orthogonal direction D2, and the third orthogonal direction D3 are different directions from each other. That is, the first contact-and-move member 6a, the second contact-and-move member 6b, and the third contact-and-move member 6c are curved in different directions from each other. Furthermore, the front end portions of the first contact-and-move member 6a, the second contact-and-move member 6b, and the third contact-and-move member 6c are bent toward the reference line D to be of a claw shape. In this embodiment, the claw-shaped end portions of the first contact-and-move member 6a, the second contact-and-move member 6b, and the third contact-and-move member 6c are bent approximately 90 degrees.

The first contact-and-move member 6a, the second contact-and-move member 6b, and the third contact-and-move member 6c thus configured are positioned inside the opening-and-closing member 7. The first contact-and-move member 6a, the second contact-and-move member 6b, and the third contact-and-move member 6c extend outside the support member 2 from the opening-and-closing-member-insertion hole 2c, through the opening-and-closing member 7. The first contact-and-move member 6a, the second contact-and-move member 6b, and the third contact-and-move member 6c are configured to be elastically deformable in an approaching direction toward the reference line D. That is, the first contact-and-move member 6a, the second contact-and-move member 6b, and the third contact-and-move member 6c are configured such that their respective claw-shaped end portions come close to each other in the vicinity of the reference line D through elastic deformation. In this manner, the first contact-and-move member 6a, the second contact-and-move member 6b, and the third contact-and-move member 6c constitute the three-dimensional-contact-and-move mechanism 6 moving in the first orthogonal direction D1, the second orthogonal direction D2, and the third orthogonal direction D3 that are different directions from each other.

As shown in FIGS. 2A and 2B, the opening-and-closing member 7 is a member for bringing the first contact-and-move member 6a, the second contact-and-move member 6b, and the third contact-and-move member 6c close to the reference line D. The opening-and-closing member 7 is a tubular member with a through-hole. The inner diameter of the opening-and-closing member 7 is approximately the same as the diameter of the reference circle E. The opening-and-closing member 7 is positioned in the opening-and-closing-member-insertion hole 2c. The opening-and-closing member 7 is supported in the opening-and-closing-member-insertion hole 2c so as to be movable in the front-rear direction that is the axial direction. In a state where the opening-and-closing member 7 is disposed with the axial direction lying along the front-rear direction, the front end portion of the coupling member 5, the first contact-and-move member 6a, the second contact-and-move member 6b, and the third contact-and-move member 6c are positioned inside the opening-and-closing member 7 so as to be movable in the axial direction. A rear end portion of the opening-and-closing member 7 is connected to the opening-and-closing-extendable-link mechanism 8 through a buffer member 7b. The rear end portion of the opening-and-closing member 7 has a projecting portion 7a. The opening-and-closing member 7 is movable in the forward direction until the projecting portion 7a comes into contact with a front end portion of the support member 2.

When the opening-and-closing member 7 moves in the forward direction from the rear end portions to the front end portions of the first contact-and-move member 6a, the second contact-and-move member 6b, and the third contact-and-move member 6c, the opening-and-closing member 7 elastically deforms the first contact-and-move member 6a, the second contact-and-move member 6b, and the third contact-and-move member 6c in the approaching direction toward the reference line D as the opening-and-closing member 7 moves in the forward direction, while maintaining positions of the contact-and-move members in the front-rear direction with respect to the support member 2. That is, the movement of the opening-and-closing member 7 in the forward direction changes the first contact-and-move member 6a, the second contact-and-move member 6b, and the third contact-and-move member 6c into a closed state in which the first contact-and-move member 6a, the second contact-and-move member 6b, and the third contact-and-move member 6c are positioned close to each other. When the opening-and-closing member 7 moves in a rearward direction from the front end portions to the rear end portions of the first contact-and-move member 6a, the second contact-and-move member 6b, and the third contact-and-move member 6c, the opening-and-closing member 7 decreases a force applied to the first contact-and-move member 6a, the second contact-and-move member 6b, and the third contact-and-move member 6c to zero, so that the first contact-and-move member 6a, the second contact-and-move member 6b, and the third contact-and-move member 6c are elastically deformed in the leaving direction from the reference line D, while maintaining the positions of the contact-and-move members in the front-rear direction with respect to the support member 2. That is, the movement of the opening-and-closing member 7 in the rearward direction changes the first contact-and-move member 6a, the second contact-and-move member 6b, and the third contact-and-move member 6c into an opened state in which the first contact-and-move member 6a, the second contact-and-move member 6b, and the third contact-and-move member 6c are positioned apart from each other.

With this configuration, the first contact-and-move member 6a and the second contact-and-move member 6b move relative to each other. The first contact-and-move member 6a and the third contact-and-move member 6c move relative to each other. The second contact-and-move member 6b and the third contact-and-move member 6c move relative to each other. That is, the first contact-and-move member 6a, the second contact-and-move member 6b, and the third contact-and-move member 6c function as the three-dimensional-contact-and-move mechanism 6 in which the first contact-and-move member 6a, the second contact-and-move member 6b, and the third contact-and-move member 6c move relative to each other in respective different orthogonal directions to the front-rear direction of the end effector 1 by the opening-and-closing member 7, while maintaining their positions in the front-rear direction with respect to the support member 2. In the three-dimensional-contact-and-move mechanism 6, the first contact-and-move member 6a, the second contact-and-move member 6b, and the third contact-and-move member 6c approach the grape stem G from the different directions. This provides the three-dimensional-contact-and-move mechanism 6 with an enlarged region in which to grab the grape stem G, from a two-dimensional region to a three-dimensional region.

The opening-and-closing-extendable-link mechanism 8 is a link mechanism for moving the opening-and-closing member 7 in the front-rear direction. The opening-and-closing-extendable-link mechanism 8 has an input swing axis for opening and closing (opening-and-closing-input-swing axis) 8a, a first input link for opening and closing (opening-and-closing-first-input link) 8b, a second input link for opening and closing (opening-and-closing-second-input link) 8c, a first intermediate link for opening and closing (opening-and-closing-first-intermediate link) 8f, a second intermediate link for opening and closing (opening-and-closing-second-intermediate link) 8g, the opening-and-closing-intermediate-swing axis 8h, a first output link for opening and closing (opening-and-closing-first-output link) 8i, a second output link for opening and closing (opening-and-closing-second-output link) 8j, and an output swing axis for opening and closing (opening-and-closing-output-swing axis) 8n. The opening-and-closing-extendable-link mechanism 8 is supported by the coupling member 5 with an extending and contracting direction thereof lying along the front-rear direction.

In the opening-and-closing-extendable-link mechanism 8, the opening-and-closing-input-swing axis 8a, the opening-and-closing-first-input link 8b and the opening-and-closing-second-input link 8c, the opening-and-closing-first-intermediate link 8f and the opening-and-closing-second-intermediate link 8g, and the opening-and-closing-first-output link 8i, the opening-and-closing-second-output link 8j and the opening-and-closing-output-swing axis 8n, are coupled in this order from a rear end portion toward a front end portion of the opening-and-closing-extendable-link mechanism 8. The opening-and-closing-input-swing axis 8a positioned in the rear end portion of the opening-and-closing-extendable-link mechanism 8 is coupled to the piston rod 3a of the electric cylinder 3. The opening-and-closing-output-swing axis 8n positioned in the front end portion of the opening-and-closing-extendable-link mechanism 8 is coupled to the opening-and-closing member 7 through the buffer member 7b.

The opening-and-closing-first-input link 8b and the opening-and-closing-second-input link 8c are links to which a driving force is input from the electric cylinder 3. A rear end portion of the opening-and-closing-first-input link 8b and a rear end portion of the opening-and-closing-second-input link 8c are swingably coupled to the piston rod 3a of the electric cylinder 3 by the opening-and-closing-input-swing axis 8a. In this state, the rear end portion of the opening-and-closing-first-input link 8b is positioned over the rear end portion of the opening-and-closing-second-input link 8c. The opening-and-closing-first-input link 8b extends in a left direction with respect to the front-rear direction from the opening-and-closing-input-swing axis 8a. A first-left-coupling axis for opening and closing (opening-and-closing-first-left-coupling axis) 8d is positioned in a front end portion of the opening-and-closing-first-input link 8b. The opening-and-closing-second-input link 8c extends in a right direction with respect to the front-rear direction from the opening-and-closing-input-swing axis 8a. A second-right-coupling axis for opening and closing (opening-and-closing-second-right-coupling axis) 8e is positioned in a front end portion of the opening-and-closing-second-input link 8c.

The opening-and-closing-first-intermediate link 8f and the opening-and-closing-second-intermediate link 8g are links for transmitting driving forces from the opening-and-closing-first-input link 8b and the opening-and-closing-second-input link 8c to the opening-and-closing-first-output link 8i and the opening-and-closing-second-output link 8j. A rear end portion of the opening-and-closing-first-intermediate link 8f is swingably coupled to the front end portion of the opening-and-closing-first-input link 8b by the opening-and-closing-first-left-coupling axis 8d. In this state, the rear end portion of the opening-and-closing-first-intermediate link 8f is positioned under the front end portion of the opening-and-closing-first-input link 8b. A rear end portion of the opening-and-closing-second-intermediate link 8g is swingably coupled to the front end portion of the opening-and-closing-second-input link 8c by the opening-and-closing-second-right-coupling axis 8e. In this state, the rear end portion of the opening-and-closing-second-intermediate link 8g is positioned over the front end portion of the opening-and-closing-second-input link 8c.

The opening-and-closing-first-intermediate link 8f extends in the right direction with respect to the front-rear direction from the opening-and-closing-first-left-coupling axis 8d. The opening-and-closing-second-intermediate link 8g extends in the left direction with respect to the front-rear direction from the opening-and-closing-second-right-coupling axis 8e. The opening-and-closing-first-intermediate link 8f and the opening-and-closing-second-intermediate link 8g intersect each other at their respective midpoint positions. In this state, a midpoint part of the opening-and-closing-first-intermediate link 8f is positioned under a midpoint part of the opening-and-closing-second-intermediate link 8g.

The opening-and-closing-intermediate-swing axis 8h is positioned at the midpoint of the opening-and-closing-first-intermediate link 8f and the midpoint of the opening-and-closing-second-intermediate link 8g. The opening-and-closing-first-intermediate link 8f and the opening-and-closing-second-intermediate link 8g are swingably coupled to each other at their respective midpoints by the opening-and-closing-intermediate-swing axis 8h. The opening-and-closing-intermediate-swing axis 8h is fixed to the coupling member 5. That is, the opening-and-closing-first-intermediate link 8f and the opening-and-closing-second-intermediate link 8g are supported by the coupling member 5 through the opening-and-closing-intermediate-swing axis 8h. A first-right-coupling axis for opening and closing (opening-and-closing-first-right-coupling axis) 8k is positioned in a front end portion of the opening-and-closing-first-intermediate link 8f A second-left-coupling axis for opening and closing (opening-and-closing-second-left-coupling axis) 81 is positioned in a front end portion of the opening-and-closing-second-intermediate link 8g.

The opening-and-closing-first-output link 8i and the opening-and-closing-second-output link 8j are links for outputting driving forces input from the opening-and-closing-first-intermediate link 8f and the opening-and-closing-second-intermediate link 8g. A rear end portion of the opening-and-closing-first-output link 8i is swingably coupled to the front end portion of the opening-and-closing-first-intermediate link 8f by the opening-and-closing-first-right-coupling axis 8k. In this state, the rear end portion of the opening-and-closing-first-output link 8i is positioned over the front end portion of the opening-and-closing-first-intermediate link 8f. A rear end portion of the opening-and-closing-second-output link 8j is swingably coupled to the front end portion of the opening-and-closing-second-intermediate link 8g by the opening-and-closing-second-left-coupling axis 8l. In this state, the rear end portion of the opening-and-closing-second-output link 8j is positioned under the front end portion of the opening-and-closing-second-intermediate link 8g.

The opening-and-closing-first-output link 8i extends in the left direction with respect to the front-rear direction from the opening-and-closing-first-right-coupling axis 8k. The opening-and-closing-second-output link 8j extends in the right direction with respect to the front-rear direction from the opening-and-closing-second-left-coupling axis 8l. A front end portion of the opening-and-closing-first-output link 8i and a front end portion of the opening-and-closing-second-output link 8j are swingably coupled to the opening-and-closing member 7 by the opening-and-closing-output-swing axis 8n. In this state, the front end portion of the opening-and-closing-first-output link 8i is positioned over the front end portion of the opening-and-closing-second-output link 8j.

As shown in FIG. 4, when the opening-and-closing-input-swing axis 8a is moved in the rearward direction (see arrow X) in the opening-and-closing-extendable-link mechanism 8, the opening-and-closing-first-input link 8b rotates clockwise (see the arrow) with the opening-and-closing-input-swing axis 8a as a rotation center. The opening-and-closing-second-input link 8c rotates counterclockwise (see the arrow) with the opening-and-closing-input-swing axis 8a as a rotation center. This increases a distance in the front-rear direction between the opening-and-closing-input-swing axis 8a and the opening-and-closing-first-left-coupling axis 8d, as well as a distance in the front-rear direction between the opening-and-closing-input-swing axis 8a and the opening-and-closing-second-right-coupling axis 8e.

With the clockwise rotation of the opening-and-closing-first-input link 8b, the opening-and-closing-first-intermediate link 8f coupled to the front end portion of the opening-and-closing-first-input link 8b by the opening-and-closing-first-left-coupling axis 8d rotates counterclockwise (see the arrow) with the opening-and-closing-intermediate-swing axis 8h as a rotation center. With the counterclockwise rotation of the opening-and-closing-second-input link 8c, the opening-and-closing-second-intermediate link 8g coupled to the front end portion of the opening-and-closing-second-input link 8c by the opening-and-closing-second-right-coupling axis 8e rotates clockwise (see the arrow) with the opening-and-closing-intermediate-swing axis 8h as a rotation center. This increases a distance in the front-rear direction between the opening-and-closing-intermediate-swing axis 8h and the opening-and-closing-first-left-coupling axis 8d, as well as a distance in the front-rear direction between the opening-and-closing-intermediate-swing axis 8h and the opening-and-closing-second-left-coupling axis 8l. Likewise, a distance in the front-rear direction between the opening-and-closing-intermediate-swing axis 8h and the opening-and-closing-first-right-coupling axis 8k, as well as a distance in the front-rear direction between the opening-and-closing-intermediate-swing axis 8h and the opening-and-closing-second-right-coupling axis 8e are increased.

With the counterclockwise rotation of the opening-and-closing-first-intermediate link 8f, the opening-and-closing-first-output link 8i coupled to the front end portion of the opening-and-closing-first-intermediate link 8f by the opening-and-closing-first-right-coupling axis 8k rotates clockwise (see the arrow) with the opening-and-closing-output-swing axis 8n as a rotation center. With the clockwise rotation of the opening-and-closing-second-intermediate link 8g, the opening-and-closing-second-output link 8j coupled to the front end portion of the opening-and-closing-second-intermediate link 8g by the opening-and-closing-second-left-coupling axis 8l rotates counterclockwise (see the arrow) with the opening-and-closing-output-swing axis 8n as a rotation center. This increases a distance in the front-rear direction between the opening-and-closing-output-swing axis 8n and the opening-and-closing-first-right-coupling axis 8k, as well as a distance in the front-rear direction between the opening-and-closing-output-swing axis 8n and the opening-and-closing-second-left-coupling axis 8l.

When the opening-and-closing-extendable-link mechanism 8 moves the opening-and-closing-input-swing axis 8a in the rearward direction by the piston rod 3a of the electric cylinder 3, the opening-and-closing-output-swing axis 8n moves in the forward direction (see arrow Y) along with an increase in a rearward length between the opening-and-closing-intermediate-swing axis 8h and the opening-and-closing-input-swing axis 8a. The opening-and-closing-extendable-link mechanism 8 thereby moves the opening-and-closing member 7, to which the opening-and-closing-output-swing axis 8n is coupled through the buffer member 7b, in the forward direction by using the opening-and-closing-intermediate-swing axis 8h as a base.

When the opening-and-closing-extendable-link mechanism 8 moves the opening-and-closing-input-swing axis 8a in the forward direction, a forward length between the opening-and-closing-intermediate-swing axis 8h and the opening-and-closing-output-swing axis 8n decreases along with a decrease in the rearward length between the opening-and-closing-intermediate-swing axis 8h and the opening-and-closing-input-swing axis 8a. The opening-and-closing-extendable-link mechanism 8 thereby moves the opening-and-closing member 7, to which the opening-and-closing-output-swing axis 8n is coupled through the buffer member 7b, in the rearward direction by using the opening-and-closing-intermediate-swing axis 8h as a base.

The buffer member 7b is a member for absorbing an amount of extension of the opening-and-closing-extendable-link mechanism 8 exerted on the opening-and-closing member 7 located at the furthest forward position. The buffer member 7b is a compression spring, for example. The buffer member 7b is positioned between the opening-and-closing member 7 and the opening-and-closing-output-swing axis 8n of the opening-and-closing-extendable-link mechanism 8, with an extending and contracting direction of the compression spring lying along the front-rear direction. A rear end portion of the buffer member 7b is coupled to the opening-and-closing-output-swing axis 8n. A front end portion of the buffer member 7b is coupled to the opening-and-closing member 7.

In a state where the projecting portion 7a of the opening-and-closing member 7 is in contact with the front end portion of the support member 2, and when the opening-and-closing-input-swing axis 8a of the opening-and-closing-extendable-link mechanism 8 moves further in the rearward direction, the buffer member 7b is compressed in the forward direction by the opening-and-closing-output-swing axis 8n in accordance with an amount of extension of the opening-and-closing-extendable-link mechanism 8. Accordingly, the opening-and-closing-input-swing axis 8a of the opening-and-closing-extendable-link mechanism 8 is movable in the rearward direction through compression of the buffer member 7b even when the opening-and-closing member 7 is located at the furthest forward position.

The opening-and-closing-guide member 9 is a member for guiding the opening-and-closing-extendable-link mechanism 8 in the front-rear direction. The opening-and-closing-guide member 9 is a grooved cam. The opening-and-closing-guide member 9 is positioned both at left and at right of the opening-and-closing-extendable-link mechanism 8 with respect to the front-rear direction. The left opening-and-closing-guide member 9 positioned at the left of the opening-and-closing-extendable-link mechanism 8 has a circular-arc guide surface 9a that is curved toward the left, and a linear guide surface 9b that extends in a front-rear direction of the circular-arc guide surface 9a. The right opening-and-closing-guide member 9 positioned at the right of the opening-and-closing-extendable-link mechanism 8 has a circular-arc guide surface 9a that is curved toward the right, and a linear guide surface 9b that extends in a front-rear direction of the circular-arc guide surface 9a. The left opening-and-closing-guide member 9 and the right opening-and-closing-guide member 9 are symmetrically positioned with respect to a line of symmetry that is a virtual line passing through the opening-and-closing-intermediate-swing axis 8h of the opening-and-closing-extendable-link mechanism 8 in the front-rear direction. The circular-arc guide surfaces 9a of the left opening-and-closing-guide member 9 and the right opening-and-closing-guide member 9 constitute a part of a circle with its center on the opening-and-closing-intermediate-swing axis 8h.

The left opening-and-closing-guide member 9 is contacted by the rear end portion of the opening-and-closing-first-intermediate link 8f and the front end portion of the opening-and-closing-second-intermediate link 8g. The right opening-and-closing-guide member 9 is contacted by the front end portion of the opening-and-closing-first-intermediate link 8f and the rear end portion of the opening-and-closing-second-intermediate link 8g. That is, when the opening-and-closing-extendable-link mechanism 8 extends and contracts with the circular-arc guide surfaces 9a contacted by the end portions of the opening-and-closing-first-intermediate link 8f and the opening-and-closing-second-intermediate link 8g, the opening-and-closing-intermediate-swing axis 8h that supports the centers of the opening-and-closing-first-intermediate link 8f and the opening-and-closing-second-intermediate link 8g is positioned at the center of the circular arcs of the circular-arc guide surfaces 9a.

The opening-and-closing-extendable-link mechanism 8 is disposed such that the opening-and-closing-first-intermediate link 8f and the opening-and-closing-second-intermediate link 8g make contact with the circular-arc guide surfaces 9a of the opening-and-closing-guide members 9 in a range of the furthest forward position to the furthest rearward position of the opening-and-closing member 7 in which the opening-and-closing member 7 is allowed to move. The opening-and-closing-first-intermediate link 8f and the opening-and-closing-second-intermediate link 8g move along the circular-arc guide surfaces 9a of the opening-and-closing-guide members 9 in respective rotation directions with the opening-and-closing-intermediate-swing axis 8h as the center. On the other hand, movements in the front-rear direction and in the left-right direction of the opening-and-closing-first-intermediate link 8f and the opening-and-closing-second-intermediate link 8g are restricted by the left and right circular-arc guide surfaces 9a contacted by these links. That is, the position in the front-rear direction and in the left-right direction of the opening-and-closing-intermediate-swing axis 8h of the opening-and-closing-extendable-link mechanism 8 with respect to the support member 2 is held, in a range of extension and contraction for moving the opening-and-closing member 7 in the front-rear direction.

As shown in FIG. 5, when the opening-and-closing-extendable-link mechanism 8 extends beyond the range of extension and contraction for moving the opening-and-closing member 7 in the front-rear direction (see arrow X), the rear end portion of the opening-and-closing-first-intermediate link 8f and the rear end portion of the opening-and-closing-second-intermediate link 8g move from the circular-arc guide surfaces 9a in the opening-and-closing-guide members 9 to the linear guide surfaces 9b extending rearward in the opening-and-closing-guide members 9. Likewise, the front end portion of the opening-and-closing-first-intermediate link 8f and the front end portion of the opening-and-closing-second-intermediate link 8g move from the circular-arc guide surfaces 9a in the opening-and-closing-guide members 9 to the linear guide surfaces 9b extending rearward in the opening-and-closing-guide members 9. With this configuration, movements in the front-rear direction and in the left-right direction of the opening-and-closing-first-intermediate link 8f and the opening-and-closing-second-intermediate link 8g are not restricted by the left and right circular-arc guide surfaces 9a. That is, the opening-and-closing-intermediate-swing axis 8h of the opening-and-closing-extendable-link mechanism 8 is movable in the front-rear direction with respect to the support member 2. The opening-and-closing-extendable-link mechanism 8 moves the opening-and-closing member 7, to which the opening-and-closing-output-swing axis 8n is coupled through the buffer member 7b, in the rearward direction (see arrow Y).

<Processing Mechanism 10>

As shown in FIG. 6, the processing mechanism 10 is a mechanism for performing processing for cutting the grape stem G on the processing portion Ta. The processing mechanism 10 includes the processing blade 11 and an extendable link mechanism for processing (processing-extendable-link mechanism) 12.

The processing blade 11 cuts the grape stem G. The processing blade 11 is a rectangular plate-like member. The processing blade 11 is positioned above the opening-and-closing member 7 in the opening-and-closing-member-insertion hole 2c with a longitudinal direction of the processing blade 11 lying along the front-rear direction. The processing blade 11 is supported by the opening-and-closing member 7 so as to be movable in the front-rear direction. A front end portion of the processing blade 11 has a cutting edge. A rear end portion of the processing blade 11 is coupled to the processing-extendable-link mechanism 12.

The processing-extendable-link mechanism 12 is a mechanism for moving the opening-and-closing member 7 in the front-rear direction. The processing-extendable-link mechanism 12 has an input swing axis for processing (processing-input-swing axis) 12a, a first input link for processing (processing-first-input link) 12b, a second input link for processing (processing-second-input link) 12c, a first intermediate link for processing (processing-first-intermediate link) 12f, a second intermediate link for processing (processing-second-intermediate link) 12g, an intermediate swing axis for processing (processing-intermediate-swing axis) 12h, a first output link for processing (processing-first-output link) 12i, a second output link for processing (processing-second-output link) 12j, and an output swing axis for processing (processing-output-swing axis) 12n. The processing-extendable-link mechanism 12 is supported by the support member 2 with an extending and contracting direction thereof lying along the front-rear direction.

In the processing-extendable-link mechanism 12, the processing-input-swing axis 12a, the processing-first-input link 12b and the processing-second-input link 12c, the processing-first-intermediate link 12f and the processing-second-intermediate link 12g, and the processing-first-output link 12i, the processing-second-output link 12j and the processing-output-swing axis 12n, are coupled in this order from a rear end portion toward a front end portion of the processing-extendable-link mechanism 12. The processing-extendable-link mechanism 12 is positioned above the opening-and-closing-extendable-link mechanism 8 with the extending and contracting direction of the processing-extendable-link mechanism 12 lying along the front-rear direction.

The processing-extendable-link mechanism 12 is supported by the support member 2 through the processing-intermediate-swing axis 12h. This allows the processing-extendable-link mechanism 12 to hold its position in the front-rear direction and in the left-right direction with respect to the support member 2. A lower end portion of the processing-input-swing axis 12a positioned in the rear end portion of the processing-extendable-link mechanism 12 is coupled to an upper end portion of the opening-and-closing-intermediate-swing axis 8h of the opening-and-closing-extendable-link mechanism 8. That is, the processing-input-swing axis 12a of the processing-extendable-link mechanism 12 is coupled to the coupling member 5. The processing-output-swing axis 12n positioned in the front end portion of the processing-extendable-link mechanism 12 is coupled to the processing blade 11.

The processing-first-input link 12b and the processing-second-input link 12c are links into which a driving force is input from the opening-and-closing-intermediate-swing axis 8h supporting the processing-input-swing axis 12a. A rear end portion of the processing-first-input link 12b and a rear end portion of the processing-second-input link 12c are swingably coupled to the processing-input-swing axis 12a. In this state, the rear end portion of the processing-first-input link 12b is positioned under the rear end portion of the processing-second-input link 12c. The processing-first-input link 12b extends in the left direction with respect to the front-rear direction from the processing-input-swing axis 12a. A first-left-coupling axis for processing (processing-first-left-coupling axis) 12d is positioned in a front end portion of the processing-first-input link 12b. The processing-second-input link 12c extends in the right direction with respect to the front-rear direction from the processing-input-swing axis 12a. A second-right-coupling axis for processing (processing-second-right-coupling axis) 12e is positioned in a front end portion of the processing-second-input link 12c.

The processing-first-intermediate link 12f and the processing-second-intermediate link 12g are links for transmitting driving forces from the processing-first-input link 12b and the processing-second-input link 12c to the processing-first-output link 12i and the processing-second-output link 12j. A rear end portion of the processing-first-intermediate link 12f is swingably coupled to the front end portion of the processing-first-input link 12b by the processing-first-left-coupling axis 12d. In this state, the rear end portion of the processing-first-intermediate link 12f is positioned over the front end portion of the processing-first-input link 12b. A rear end portion of the processing-second-intermediate link 12g is swingably coupled to the front end portion of the processing-second-input link 12c by the processing-second-right-coupling axis 12e. In this state, the rear end portion of the processing-second-intermediate link 12g is positioned under the front end portion of the processing-second-input link 12c.

The processing-first-intermediate link 12f extends in the right direction with respect to the front-rear direction from the processing-first-left-coupling axis 12d. The processing-second-intermediate link 12g extends in the left direction with respect to the front-rear direction from the processing-second-right-coupling axis 12e. The processing-first-intermediate link 12f and the processing-second-intermediate link 12g intersect each other at their respective midpoint positions. In this state, a midpoint part of the processing-first-intermediate link 12f is positioned over a midpoint part of the processing-second-intermediate link 12g.

The processing-intermediate-swing axis 12h is positioned at the midpoint of the processing-first-intermediate link 12f and the midpoint of the processing-second-intermediate link 12g. The processing-first-intermediate link 12f and the processing-second-intermediate link 12g are swingably coupled to each other at their respective midpoints by the processing-intermediate-swing axis 12h. The processing-intermediate-swing axis 12h is fixed to a guide member for processing (processing guide member) 13. That is, the processing-first-intermediate link 12f and the processing-second-intermediate link 12g are supported by the processing guide member 13 through the processing-intermediate-swing axis 12h. A first-right-coupling axis for processing (processing-first-right-coupling axis) 12k is positioned in a front end portion of the processing-first-intermediate link 12f. A second-left-coupling axis for processing (processing-second-left-coupling axis) 121 is positioned in a front end portion of the processing-second-intermediate link 12g.

The processing-first-output link 12i and the processing-second-output link 12j are links for outputting driving forces input from the processing-first-intermediate link 12f and the processing-second-intermediate link 12g. A rear end portion of the processing-first-output link 12i is swingably coupled to the front end portion of the processing-first-intermediate link 12f by the processing-first-right-coupling axis 12k. In this state, the rear end portion of the processing-first-output link 12i is positioned under the front end portion of the processing-first-intermediate link 12f A rear end portion of the processing-second-output link 12j is swingably coupled to the front end portion of the processing-second-intermediate link 12g by the processing-second-left-coupling axis 12l. In this state, the rear end portion of the processing-second-output link 12j is positioned over the front end portion of the processing-second-intermediate link 12g.

The processing-first-output link 12i extends in the left direction with respect to the front-rear direction from the processing-first-right-coupling axis 12k. The processing-second-output link 12j extends in the right direction with respect to the front-rear direction from the processing-second-left-coupling axis 12l. A front end portion of the processing-first-output link 12i and a front end portion of the processing-second-output link 12j are swingably coupled to the opening-and-closing member 7 by the processing-output-swing axis 12n. In this state, the front end portion of the processing-first-output link 12i is positioned under the front end portion of the processing-second-output link 12j.

As shown in FIG. 7, when the processing-input-swing axis 12a is moved in the rearward direction (see arrow X) in the processing-extendable-link mechanism 12, the processing-first-input link 12b rotates clockwise (see the arrow) with the processing-input-swing axis 12a as a rotation center. In the same situation, the processing-second-input link 12c rotates counterclockwise (see the arrow) with the processing-input-swing axis 12a as a rotation center. This increases a distance in the front-rear direction between the processing-input-swing axis 12a and the processing-first-left-coupling axis 12d, as well as a distance in the front-rear direction between the processing-input-swing axis 12a and the processing-second-right-coupling axis 12e.

With the clockwise rotation of the processing-first-input link 12b, the processing-first-intermediate link 12f coupled to the front end portion of the processing-first-input link 12b by the processing-first-left-coupling axis 12d rotates counterclockwise (see the arrow) with the processing-intermediate-swing axis 12h as a rotation center. With the counterclockwise rotation of the processing-second-input link 12c, the processing-second-intermediate link 12g coupled to the front end portion of the processing-second-input link 12c by the processing-second-right-coupling axis 12e rotates clockwise (see the arrow) with the processing-intermediate-swing axis 12h as a rotation center. This increases a distance in the front-rear direction between the processing-intermediate-swing axis 12h and the processing-first-left-coupling axis 12d, as well as a distance in the front-rear direction between the processing-intermediate-swing axis 12h and the processing-second-left-coupling axis 12l. Likewise, a distance in the front-rear direction between the processing-intermediate-swing axis 12h and the processing-first-right-coupling axis 12k, as well as a distance in the front-rear direction between the processing-intermediate-swing axis 12h and the processing-second-right-coupling axis 12e are increased.

With the counterclockwise rotation of the processing-first-intermediate link 12f, the processing-first-output link 12i coupled to the front end portion of the processing-first-intermediate link 12f by the processing-first-right-coupling axis 12k rotates clockwise (see the arrow) with the processing-output-swing axis 12n as a rotation center. With the clockwise rotation of the processing-second-intermediate link 12g, the processing-second-output link 12j coupled to the front end portion of the processing-second-intermediate link 12g by the processing-second-left-coupling axis 12l rotates counterclockwise (see the arrow) with the processing-output-swing axis 12n as a rotation center. This increases a distance in the front-rear direction between the processing-output-swing axis 12n and the processing-first-right-coupling axis 12k, as well as a distance in the front-rear direction between the processing-output-swing axis 12n and the processing-second-left-coupling axis 12l.

When the processing-extendable-link mechanism 12 moves the processing-input-swing axis 12a in the rearward direction as the opening-and-closing-intermediate-swing axis 8h of the opening-and-closing-extendable-link mechanism 8 moves in the rearward direction, the processing-output-swing axis 12n moves in the forward direction (see arrow Y) along with an increase in a rearward length between the processing-intermediate-swing axis 12h and the processing-input-swing axis 12a. The processing-extendable-link mechanism 12 thereby moves the processing blade 11, to which the processing-output-swing axis 12n is coupled, in the forward direction by using the processing-intermediate-swing axis 12h as a base. When the processing-extendable-link mechanism 12 moves the processing-input-swing axis 12a in the forward direction, a forward length between the processing-intermediate-swing axis 12h and the processing-output-swing axis 12n decreases along with a decrease in the rearward length between the processing-intermediate-swing axis 12h and the processing-input-swing axis 12a. The processing-extendable-link mechanism 12 thereby moves the processing blade 11, to which the processing-output-swing axis 12n is coupled, in the rearward direction by using the processing-intermediate-swing axis 12h as a base.

The end effector 1 thus configured has a configuration in which the target-object-positioning mechanism 4 and the processing mechanism 10 operate in conjunction with each other through the opening-and-closing-intermediate-swing axis 8h. That is, in the end effector 1, the target-object-positioning mechanism 4 and the processing mechanism 10 are operated by the single electric cylinder 3. Naturally, the end effector 1 does not have actuators, each moving one of the first contact-and-move member 6a, the second contact-and-move member 6b, and the third contact-and-move member 6c, individually. Thus, the size, weight and moment of inertia of the end effector 1 are small, compared with a case where the end effector has actuators for individual operation of each of the first contact-and-move member 6a, the second contact-and-move member 6b, and the third contact-and-move member 6c. This allows the end effector 1 to suppress interference with objects around a target object, while reducing the time required to move the end effector 1 and the energy required to move the end effector 1, without highly precisely moving the work machine that moves the end effector 1.

<Operation of Each Mechanism>

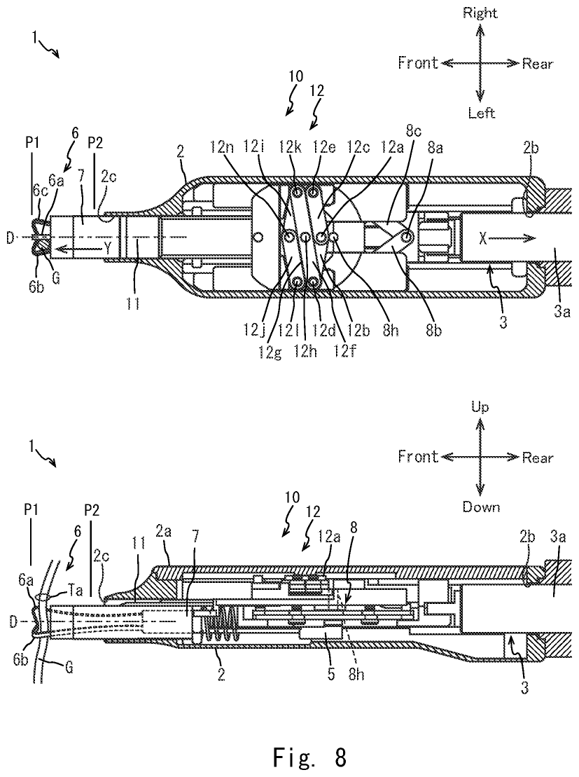

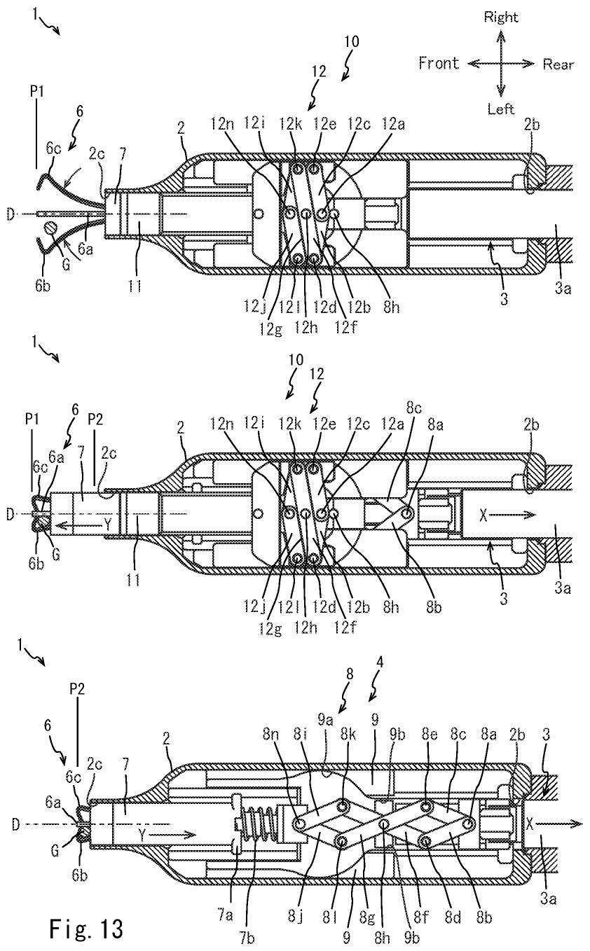

Operations of the target-object-positioning mechanism 4 and the processing mechanism 10 of the end effector 1 will now be described with reference to FIGS. 6 to 8 and 13. FIG. 8 is a plan view of the inside of the end effector 1, and a cross-sectional side view of the end effector 1, in a state where the target-object-positioning mechanism 4 and the processing mechanism 10 have moved to the grabbing position P1. FIG. 13 is a cross-sectional view of the end effector 1 that is viewed in the direction of arrow C in FIG. 2A when the processing mechanism 10 has positioned the grape stem G at the grabbing position P1, a cross-sectional view of the end effector 1 that is viewed in the direction of arrow C in FIG. 2A when the target-object-positioning mechanism 4 and the processing mechanism 10 have moved to the grabbing position P1, and a cross-sectional view of the end effector 1 that is viewed in the direction of arrow B in FIG. 2A when the target-object-positioning mechanism 4 has moved the grape stem G to the processing position P2. The end effector 1 performs a grabbing process by the target-object-positioning mechanism 4, a positioning process by the target-object-positioning mechanism 4, a processing process by the processing mechanism 10, and a release process by the target-object-positioning mechanism 4.

As shown in FIGS. 6 and 13, in the grabbing process by the target-object-positioning mechanism 4, the end effector 1 is moved by the work machine so that the grape stem G is included in a region surrounded by the first contact-and-move member 6a, the second contact-and-move member 6b, and the third contact-and-move member 6c.

As shown in FIGS. 8 and 13, the end effector 1 moves the opening-and-closing-input-swing axis 8a of the opening-and-closing-extendable-link mechanism 8 in the rearward direction by the electric cylinder 3 (see arrow X). The opening-and-closing-extendable-link mechanism 8 extends in the rearward direction and in the forward direction by using the opening-and-closing-intermediate-swing axis 8h as a base. The opening-and-closing-extendable-link mechanism 8 thereby moves the opening-and-closing member 7 coupled to the opening-and-closing-output-swing axis 8n, in the forward direction (see arrow Y).

With the movement of the opening-and-closing member 7 in the forward direction, the opening-and-closing member 7 causes the claw-shaped end portions of the first contact-and-move member 6a, the second contact-and-move member 6b, and the third contact-and-move member 6c that constitute the three-dimensional-contact-and-move mechanism 6 to move in the approaching direction toward the reference line D extending in the front-rear direction. That is, the opening-and-closing member 7 moves the first contact-and-move member 6a, the second contact-and-move member 6b, and the third contact-and-move member 6c in the orthogonal directions to the reference line D. At this time, the support member 2, the first contact-and-move member 6a, the second contact-and-move member 6b, and the third contact-and-move member 6c do not move in the front-rear direction. The opening-and-closing member 7 moves in the forward direction up to a position at which the projecting portion 7a comes into contact with the front end portion of the support member 2. When the first contact-and-move member 6a, the second contact-and-move member 6b, and the third contact-and-move member 6c are changed into the closed state at the grabbing position P1 by the opening-and-closing member 7, the end effector 1 terminates the grabbing process of the grape stem G. The first contact-and-move member 6a, the second contact-and-move member 6b, and the third contact-and-move member 6c may make contact with a portion including a part of the processing portion Ta of the grape stem G.

As shown in FIGS. 7 and 13, in the positioning process by the target-object-positioning mechanism 4, the end effector 1 moves the opening-and-closing-input-swing axis 8a of the opening-and-closing-extendable-link mechanism 8 further in the rearward direction by the electric cylinder 3 (see arrow X). The both end portions, which are in contact with the opening-and-closing-guide members 9, of each of the opening-and-closing-first-intermediate link 8f and the opening-and-closing-second-intermediate link 8g of the opening-and-closing-extendable-link mechanism 8 move from the circular-arc guide surfaces 9a to the linear guide surfaces 9b (see FIG. 5). Accordingly, the opening-and-closing-extendable-link mechanism 8 moves in the rearward direction by the electric cylinder 3. The coupling member 5 supporting the opening-and-closing-intermediate-swing axis 8h moves in the rearward direction together with the opening-and-closing-extendable-link mechanism 8. The processing-input-swing axis 12a of the processing-extendable-link mechanism 12 moves in the rearward direction together with the coupling member 5.

The end effector 1 moves the opening-and-closing member 7 in the rearward direction through the movement of the opening-and-closing-extendable-link mechanism 8 in the rearward direction. Simultaneously, the end effector 1 moves the first contact-and-move member 6a, the second contact-and-move member 6b, and the third contact-and-move member 6c in the rearward direction through the movement of the coupling member 5 in the rearward direction. Accordingly, the first contact-and-move member 6a, the second contact-and-move member 6b, and the third contact-and-move member 6c move in the rearward direction with the grape stem G grabbed by them.

In the processing process by the processing mechanism 10, simultaneously with the movement of the grape stem G, the end effector 1 moves the processing blade 11 in the forward direction (see arrow Y) as the processing-input-swing axis 12a in the processing-extendable-link mechanism 12 moves in the rearward direction. The end effector 1 cuts the processing portion Ta as a cut portion in the grape stem G by bringing the grape stem G moving in the rearward direction into contact with the processing blade 11 moving in the forward direction. In this manner, the end effector 1 positions the processing portion Ta of the grape stem G grabbed by the first contact-and-move member 6a, the second contact-and-move member 6b, and the third contact-and-move member 6c, at the processing position P2 for the cut of the processing portion Ta by the processing blade 11. Simultaneously, the end effector 1 moves the processing blade 11 to the processing position P2.

As shown in FIGS. 8 and 13, the end effector 1 moves the coupling member 5 in the forward direction by the electric cylinder 3. At this time, the linear guide surfaces 9b of the opening-and-closing-guide members 9 restrict rotary movements of the both end portions of each of the opening-and-closing-first-intermediate link 8f and the opening-and-closing-second-intermediate link 8g of the opening-and-closing-extendable-link mechanism 8 with the opening-and-closing-intermediate-swing axis 8h as the center. Accordingly, the opening-and-closing-extendable-link mechanism 8 moves in the forward direction, while maintaining the amount of extension in the front-rear direction. The coupling member 5 supporting the opening-and-closing-intermediate-swing axis 8h moves together with the opening-and-closing-extendable-link mechanism 8 in the forward direction. The processing-input-swing axis 12a of the processing-extendable-link mechanism 12 moves in the forward direction together with the coupling member 5.

The end effector 1 moves the opening-and-closing member 7 in the forward direction through the movement of the opening-and-closing-extendable-link mechanism 8 in the forward direction. Simultaneously, the end effector 1 moves the first contact-and-move member 6a, the second contact-and-move member 6b, and the third contact-and-move member 6c in the forward direction from the processing position P2, through the movement of the coupling member 5 in the forward direction. Accordingly, the first contact-and-move member 6a, the second contact-and-move member 6b, and the third contact-and-move member 6c move in the forward direction with the cut bunch of grapes grabbed by them. Simultaneously, the end effector 1 moves the processing blade 11 in the rearward direction through the movement of the processing-input-swing axis 12a of the processing-extendable-link mechanism 12 in the forward direction. Accordingly, the end effector 1 moves the bunch of grapes having been cut off to the grabbing position P1. The end effector 1 also causes the processing blade 11 to be accommodated in the opening-and-closing-member-insertion hole 2c of the support member 2.

As shown in FIGS. 6 and 13, in the release process by the target-object-positioning mechanism 4, the end effector 1 moves the opening-and-closing-extendable-link mechanism 8 further in the forward direction by the electric cylinder 3. The both end portions of each of the opening-and-closing-first-intermediate link 8f and the opening-and-closing-second-intermediate link 8g move to the circular-arc guide surfaces 9a of the opening-and-closing-guide members 9. The opening-and-closing-first-intermediate link 8f and the opening-and-closing-second-intermediate link 8g move along the circular-arc guide surfaces 9a in the respective rotation directions with the opening-and-closing-intermediate-swing axis 8h as the center. This causes contraction of the opening-and-closing-extendable-link mechanism 8 in the front-rear direction in a state where the position of the opening-and-closing-intermediate-swing axis 8h in the front-rear direction with respect to the support member 2 is held. The coupling member 5 supporting the opening-and-closing-intermediate-swing axis 8h holds its own position in the front-rear direction. The processing-input-swing axis 12a of the processing-extendable-link mechanism 12 holds its own position in the front-rear direction together with the coupling member 5.

The end effector 1 moves the opening-and-closing member 7 in the rearward direction through the contraction of the opening-and-closing-extendable-link mechanism 8 in the front-rear direction. Simultaneously, the end effector 1 holds the first contact-and-move member 6a, the second contact-and-move member 6b, and the third contact-and-move member 6c at the grabbing position P1 by holding the position of the coupling member 5 in the front-rear direction. Simultaneously, the end effector 1 holds the processing blade 11 in the opening-and-closing-member-insertion hole 2c of the support member 2 by holding the position of the processing-input-swing axis 12a of the processing-extendable-link mechanism 12 in the front-rear direction. Accordingly, the end effector 1 changes the first contact-and-move member 6a, the second contact-and-move member 6b, and the third contact-and-move member 6c into the opened state in which the first contact-and-move member 6a, the second contact-and-move member 6b, and the third contact-and-move member 6c are positioned apart from each other at the grabbing position P1.

<Contact-and-Move-Member-Moving Space S1>

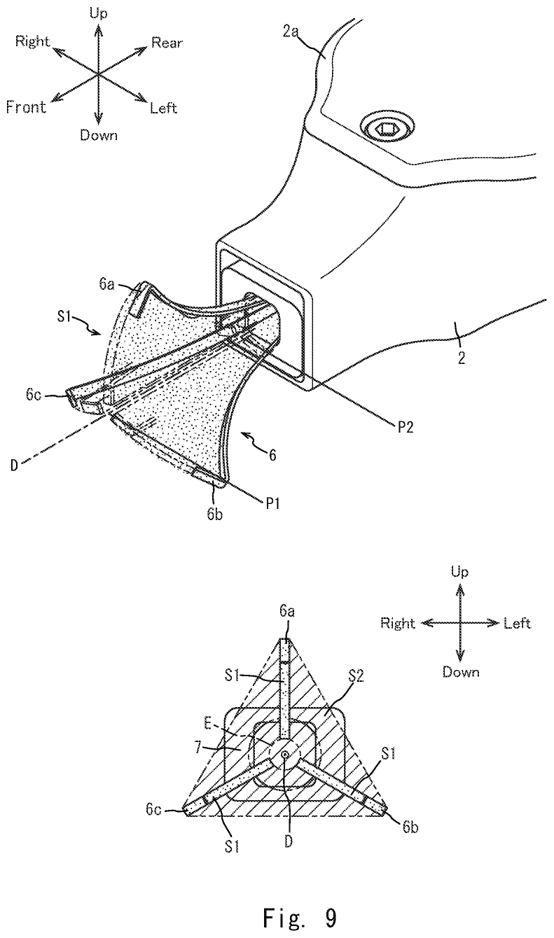

A contact-and-move-member-moving space S1 of the end effector 1 will now be described with reference to FIG. 9. FIG. 9 is a perspective view of the contact-and-move-member-moving space S1, and a front view of the contact-and-move members. The contact-and-move-member-moving space S1 refers to a space that the first contact-and-move member 6a, the second contact-and-move member 6b, and the third contact-and-move member 6c pass through when these members move.

As shown in FIG. 9, in this embodiment, the first contact-and-move member 6a, the second contact-and-move member 6b, and the third contact-and-move member 6c attached to the front end portion of the coupling member 5 are configured to be movable in the first orthogonal direction D1, the second orthogonal direction D2, and the third orthogonal direction D3, respectively, by the opening-and-closing member 7 (see FIGS. 2A and 2B). The first contact-and-move member 6a, the second contact-and-move member 6b, and the third contact-and-move member 6c are configured to be movable from the grabbing position P1 to the processing position P2 by the coupling member 5.

Thus, the end effector 1 has the contact-and-move-member-moving space S1 including a space that the first contact-and-move member 6a, the second contact-and-move member 6b, and the third contact-and-move member 6c pass through when moving from a position, at which the members are in the opened state, to the grabbing position P1 at which the members are in the closed state while maintaining their own positions in the front-rear direction with respect to the support member 2, and a space that the first contact-and-move member 6a, the second contact-and-move member 6b, and the third contact-and-move member 6c in the closed state pass through when moving from the grabbing position P1 to the processing position P2 (see the pale gray portions). In this embodiment, the contact-and-move-member-moving space S1 is a space that spreads radially and, when viewed from the front, is divided by the three directions into three areas having equal central angles in the reference circle E, and also a space of which a cross-sectional area perpendicular to the front-rear direction increases in the forward direction.

When the grape stem G is included in at least a part of the contact-and-move-member-moving space S1 in the end effector 1, the end effector 1 grabs the grape stem G while at least one of the first contact-and-move member 6a, the second contact-and-move member 6b, or the third contact-and-move member 6c moving in the contact-and-move-member-moving space S1 maintains the position in the front-rear direction with respect to the support member 2. Subsequently, the end effector 1 moves the first contact-and-move member 6a, the second contact-and-move member 6b, and the third contact-and-move member 6c in the rearward direction with respect to the support member 2 with the grape stem G grabbed by these members, and positions the processing portion Ta of the grape stem G at the processing position P2. Thus, the end effector 1 can grab the grape stem G present in the contact-and-move-member-moving space S1 that is positioned forward of the processing position P2 and spreads in the directions perpendicular to the front-rear direction.

The grape stem G, which is included in a substantially triangular-pyramid-shaped space S2 surrounded by the first contact-and-move member 6a, the second contact-and-move member 6b, and the third contact-and-move member 6c, is highly likely to be included in at least a part of the three-dimensional contact-and-move-member-moving space S1. Therefore, as long as the grape stem G is positioned in the substantially triangular-pyramid-shaped space S2 (see the hatched portion) surrounded by the first contact-and-move member 6a, the second contact-and-move member 6b, and the third contact-and-move member 6c, the end effector 1 can grab the grape stem G without moving the body of the end effector 1 and move the grape stem G to the processing position P2, even when e.g., shape, position and posture of the grape stem G change.

At least a part of the contact-and-move-member-moving space S1, when viewed in the front-rear direction, overlaps the processing position P2. That is, as long as the end effector 1 can grab the grape stem G by the first contact-and-move member 6a, the second contact-and-move member 6b, and the third contact-and-move member 6c, the end effector 1 can move the grape stem G to the processing position P2 in the contact-and-move-member-moving space S1.

Furthermore, at least a part of the contact-and-move-member-moving space S1, when viewed in the front-rear direction, overlaps the support member 2. That is, even when e.g., shape, position and posture of the grape stem G change with respect to the support member 2 supporting the first contact-and-move member 6a, the second contact-and-move member 6b, and the third contact-and-move member 6c, the end effector 1 can grab the grape stem G.

As described above, the end effector 1 has the contact-and-move-member-moving space S1 that is a space spreading radially and, when viewed from the front, is divided by the three directions into three areas having equal central angles in the reference circle E, and also a space of which a cross-sectional area perpendicular to the front-rear direction increases in the forward direction. Therefore, highly precise positioning of the end effector 1 with respect to the grape stem G is not required. When the grape stem G is present in the contact-and-move-member-moving space S1, the end effector 1 can grab the grape stem G and position the processing portion Ta of the grape stem G at the processing position P2 by the first contact-and-move member 6a, the second contact-and-move member 6b, and the third contact-and-move member 6c, without moving the entirety of the end effector 1 by the work machine, such as the multi-joint robot arm, that moves the end effector 1.

The end effector 1 grabs the grape stem G present in the contact-and-move-member-moving space S1, at the grabbing position P1 by the first contact-and-move member 6a, the second contact-and-move member 6b, and the third contact-and-move member 6c, without drawing the grape stem G toward the support member 2. The end effector 1 can draw the grape stem G to the processing position P2 in a state where the first contact-and-move member 6a, the second contact-and-move member 6b, and the third contact-and-move member 6c come the closest to each other.

The contact-and-move-member-moving space S1 is shaped to expand in the forward direction, so that the end effector 1 can maintain a state where the grape stem G is included in the contact-and-move-member-moving space S1 even when e.g., shape, position and posture of the grape stem G slightly change. This allows the end effector 1 to perform processing on the processing portion Ta of the grape stem G, without increasing a moving space of the entirety of the end effector 1. That is, the end effector has increased robustness through the three-dimensional-contact-and-move mechanism 6 constituted of the first contact-and-move member 6a, the second contact-and-move member 6b, and the third contact-and-move member 6c that move three-dimensionally. Furthermore, the end effector 1 grabs the grape stem G without moving the grape stem G in the front-rear direction, which is conducive to suppressing interference with objects around the grape stem G at the time of grabbing. The end effector 1 moves the grape stem G by the first contact-and-move member 6a, the second contact-and-move member 6b, and the third contact-and-move member 6c with these members in contact with each other, so that interference with objects around the grape stem G can be suppressed at the time of positioning the grape stem G at the processing position P2.

Thus, the end effector 1 does not require highly precise control of an actuator of the work machine that moves the end effector 1 for grabbing the grape stem G. Furthermore, in the end effector 1, when the grape stem G is present in the contact-and-move-member-moving space S1, there is no need to move the entirety of the end effector 1 in the vicinity of the grape stem G. The size, weight and moment of inertia of the end effector 1 are small, compared with a case where the end effector has actuators for individual operation of each of the first contact-and-move member 6a, the second contact-and-move member 6b, the third contact-and-move member 6c, and the processing mechanism 10. This allows the end effector 1 to suppress interference with objects around the grape stem G and the grapes, while reducing the time required to move the end effector 1 and the energy required to move the end effector 1, without highly precisely moving the work machine that moves the end effector 1.

### Second Embodiment

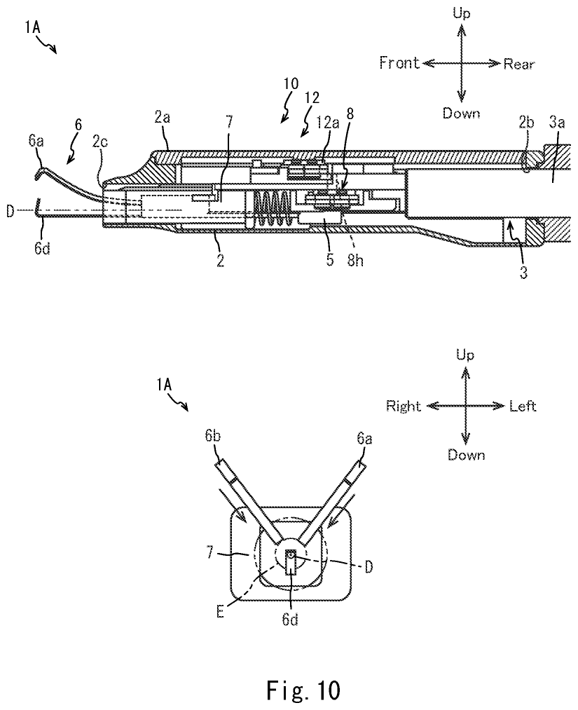

An end effector 1A according to a second embodiment of the present teaching will be described with reference to FIG. 10. FIG. 10 is a cross-sectional side view of the end effector 1A and a front view of contact-and-move members. Note that, in the following embodiment, specific description of similar points to those in the embodiment already described will be omitted and only a portion which differs from the already described embodiment will be described in detail.

As shown in FIG. 10, the end effector 1A according to the second embodiment of the present teaching differs in configuration of contact-and-move members in the target-object-positioning mechanism 4 from that of the end effector 1 according to the first embodiment.

A first contact-and-move member 6a, a second contact-and-move member 6b, and a third contact-and-move member 6d are members for grabbing the grape stem G. The first contact-and-move member 6a and the second contact-and-move member 6b are, for example, made of a material that can be easily elastically deformed upon receipt of an external force, such as a leaf spring material and resin. The third contact-and-move member 6d is, for example, made of a material not easily elastically deformed, such as steel.

In this embodiment, the first contact-and-move member 6a and the second contact-and-move member 6b are made of a rectangular, thin leaf spring material. The third contact-and-move member 6d is made of steel with higher rigidity than the first contact-and-move member 6a and the second contact-and-move member 6b. Deflection of the third contact-and-move member 6d in an orthogonal direction to the front-rear direction is sufficiently small compared with deflection of the first contact-and-move member 6a and the second contact-and-move member 6b.

The first contact-and-move member 6a and the second contact-and-move member 6b are curved such that each of their end portions is directed in an orthogonal direction to the reference line D that is a leaving direction from the reference line D, where the reference line D passes through the center of the reference circle E and extends in the front-rear direction.

The first contact-and-move member 6a and the second contact-and-move member 6b are curved in different directions from each other. That is, the first contact-and-move member 6a and the second contact-and-move member 6b constitute a part of the three-dimensional-contact-and-move mechanism 6 in which the first contact-and-move member 6a and the second contact-and-move member 6b are increasingly apart from the reference line D in the different directions, toward the front ends. The third contact-and-move member 6d extends in the front-rear direction along the reference line D. That is, the first contact-and-move member 6a and the second contact-and-move member 6b are configured such that their respective claw-shaped end portions come close to a claw-shaped end portion of the third contact-and-move member 6d through elastic deformation.

The opening-and-closing member 7 is the member for bringing the first contact-and-move member 6a and the second contact-and-move member 6b close to the third contact-and-move member 6d. When the opening-and-closing member 7 moves in the forward direction from rear end portions of the first contact-and-move member 6a, the second contact-and-move member 6b, and the third contact-and-move member 6d, the opening-and-closing member 7 elastically deforms the first contact-and-move member 6a and the second contact-and-move member 6b that are positioned apart from the reference line D, in the approaching direction toward the third contact-and-move member 6d as the opening-and-closing member 7 moves in the forward direction.

The movement of the opening-and-closing member 7 in the forward direction causes the first contact-and-move member 6a, the second contact-and-move member 6b, and the third contact-and-move member 6d to change into a closed state in which the first contact-and-move member 6a, the second contact-and-move member 6b, and the third contact-and-move member 6d are positioned close to each other. When the opening-and-closing member 7 is moved in a rearward direction from the front end portions of the first contact-and-move member 6a, the second contact-and-move member 6b, and the third contact-and-move member 6d, the first contact-and-move member 6a and the second contact-and-move member 6b are restored from the elastic deformation by elastic force. That is, the movement of the opening-and-closing member 7 in the rearward direction causes the first contact-and-move member 6a, the second contact-and-move member 6b, and the third contact-and-move member 6d to change into an opened state in which the first contact-and-move member 6a, the second contact-and-move member 6b, and the third contact-and-move member 6d are positioned apart from each other.

With this configuration, the first contact-and-move member 6a and the second contact-and-move member 6b function as the three-dimensional-contact-and-move mechanism 6 in which the first contact-and-move member 6a and the second contact-and-move member 6b move in respective different orthogonal directions to the front-rear direction of the end effector 1A by the opening-and-closing member 7. In the three-dimensional-contact-and-move mechanism 6, the first contact-and-move member 6a and the second contact-and-move member 6b approach a target object from the different directions, which is conducive to enlarging a region in which to grab the target object from a two-dimensional region to a three-dimensional region.

The end effector 1A can control the position of the end effector 1A with respect to the grape stem G by using, as a base for positioning, the third contact-and-move member 6d having higher rigidity than the first contact-and-move member 6a and the second contact-and-move member 6b. This allows the end effector 1A to suppress interference with objects around the target object, while reducing the time required to move the end effector 1A and the energy required to move the end effector 1A, without highly precisely moving the work machine that moves the end effector 1A.

### Third Embodiment

<End Effector Including Imaging Device>

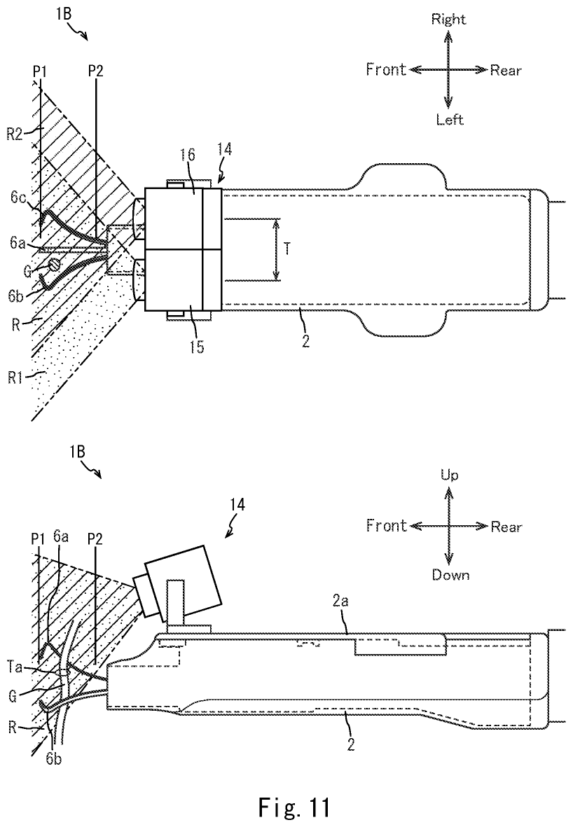

An end effector 1B according to a third embodiment of the present teaching will be described with reference to FIG. 11. FIG. 11 is a plan view and a cross-sectional side view that show an imaging area R of an imaging device of the end effector 1B according to the third embodiment of the present teaching.

As shown in FIG. 11, the end effector 1B according to the third embodiment of the present teaching differs from the end effector 1 according to the first embodiment in that the end effector 1B has a stereo camera 14 as the imaging device.

The stereo camera 14 is a camera capable of capturing parallax images. The stereo camera 14 is a camera system in which a first monocular camera 15 and a second monocular camera 16 are disposed side by side at a predetermined interval T. The first monocular camera 15 and the second monocular camera 16 are cameras for imaging a target object from a single viewpoint at a time. The first monocular camera 15 and the second monocular camera 16 are digital cameras using a CCD sensor or a CMOS sensor. The first monocular camera 15 and the second monocular camera 16 are provided side by side in the left-right direction on the end effector 1B so as to be disposed with an imaging direction lying along the forward direction. The first monocular camera 15 and the second monocular camera 16 are so configured that the imaging direction is changeable.

The stereo camera 14 is disposed in the end effector 1B such that the first contact-and-move member 6a, the second contact-and-move member 6b, and the third contact-and-move member 6c are included in the imaging area R that is an area of overlap between an imaging area R1 of the first monocular camera 15 (the pale gray portion) and an imaging area R2 of the second monocular camera 16 (the hatched portion). That is, in the stereo camera 14, the imaging area R includes the contact-and-move-member-moving space S1.

The end effector 1B thus configured causes the first contact-and-move member 6a, the second contact-and-move member 6b, and the third contact-and-move member 6c to operate in the imaging area R. Therefore, the end effector 1B can simultaneously capture an image of the grape stem G, and images of the first contact-and-move member 6a, the second contact-and-move member 6b, and the third contact-and-move member 6c by the stereo camera 14. That is, the end effector 1B can simultaneously obtain information on the processing portion Ta of the grape stem G, and information on the grabbing position P1 at which the first contact-and-move member 6a, the second contact-and-move member 6b, and the third contact-and-move member 6c make contact with the grape stem G, by the stereo camera 14. The end effector 1B can also obtain information on the processing position P2 for the grape stem G by the stereo camera 14.

Therefore, the end effector 1B provides the images taken by the stereo camera 14 to a control device of the work machine, so that the end effector 1B is moved by the work machine to include the processing portion Ta of the grape stem Gin the contact-and-move-member-moving space S1. This allows the end effector 1B to suppress interference with objects around the grapes, while reducing the time required to move the end effector 1B and the energy required to move the end effector 1B, without highly precisely moving the work machine that moves the end effector 1B.

### OTHER EMBODIMENTS

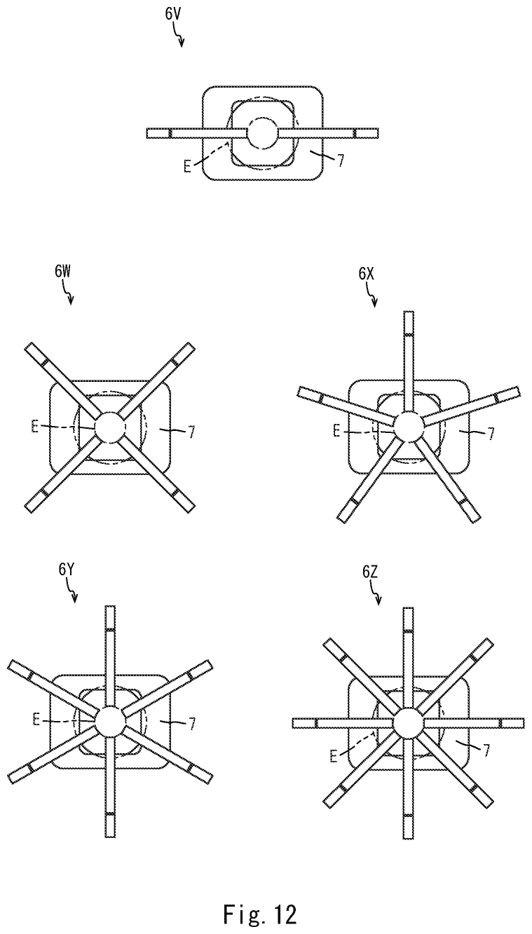

The embodiments of the present teaching have been described above, but the above-described embodiments are merely illustrative examples of preferred embodiments of the present teaching. Therefore, the present teaching is not limited to the above-described embodiments and the above-described embodiments can be appropriately modified and implemented without departing from the gist of the teaching. FIG. 12 is front views of contact-and-move members of the end effector 1 according to other embodiments of the present teaching.

In the embodiments described above, the end effector 1 has the three contact-and-move members, i.e., the first contact-and-move member 6a, the second contact-and-move member 6b, and the third contact-and-move member 6c. Alternatively, it suffices that the end effector has a plurality of contact-and-move members. That is, it suffices that the end effector has at least the first contact-and-move member moving in the first orthogonal direction, and the second contact-and-move member moving in the second orthogonal direction. With this configuration, the end effector is provided with the three-dimensional-contact-and-move mechanism 6 having the three-dimensional contact-and-move-member-moving space S1.

As shown in FIG. 12, the end effector may have, for example, a three-dimensional-contact-and-move mechanism 6V with two contact-and-move members, a three-dimensional-contact-and-move mechanism 6W with four contact-and-move members, a three-dimensional-contact-and-move mechanism 6X with five contact-and-move members, a three-dimensional-contact-and-move mechanism 6Y with six contact-and-move members, or a three-dimensional-contact-and-move mechanism 6Z with eight contact-and-move members. The contact-and-move members are positioned on the reference circle E having an arbitrary radius so as not to overlap each other. In this state, the contact-and-move members may be disposed such that respective adjacent members form equal central angles, or form different central angles. The contact-and-move members may not be disposed on the circle. The contact-and-move members may be disposed, for example, on an ellipse, on a polygon, or at random positions. The contact-and-move members are configured to be movable in respective different orthogonal directions to the front-rear direction.

The end effector thus configured causes the contact-and-move members to make contact with a plurality of positions on the grape stem G from different directions, so that grabbing the grape stem G becomes increasingly easy as the number of contact-and-move members increases. In addition, with an increase in the number of contact-and-move members, the end effector can extend the range of types, properties and shapes of target objects that can be grabbed. That is, the end effector has increased robustness through the configurations of the three-dimensional-contact-and-move mechanisms 6, 6V, 6W, 6X, 6Y, and 6Z in which the plurality of contact-and-move members moves three-dimensionally.

The end effector 1 grabs the target object by the claw-shaped end portions of the contact-and-move members. Alternatively, it suffices that the end effector can grab and draw the target object by the plurality of contact-and-move members. That is, the method of grabbing the target object by the plurality of contact-and-move members may include, in addition to the method of grabbing the target object by the claws, methods of using e.g., a friction force and an adhesive force.

In the second embodiment, the end effector 1A suppresses an amount of elastic deformation of the third contact-and-move member 6d to use the third contact-and-move member 6d as a base for grabbing the grape stem G. Alternatively, in a case where the end effector 1A has a four or more contact-and-move members, the end effector 1A may suppress an amount of elastic deformation of a plurality of contact-and-move members so that the plurality of contact-and-move members are used as a base for grabbing the grape stem G. With this configuration, the end effector 1A is provided with a base surface made by the plurality of contact-and-move members, which ensures more stable grabbing of the grape stem G. In a case where the end effector 1A has a plurality of contact-and-move members, the end effector 1 may be configured to suppress an amount of elastic deformation of all of the contact-and-move members.

In the embodiments described above, the end effector 1 moves the grape stem G grabbed in the positioning process in the rearward direction by the first contact-and-move member 6a, the second contact-and-move member 6b, and the third contact-and-move member 6c to thereby position the grape stem G at the processing position P2. Alternatively, the end effector 1 may be moved in the forward direction by the work machine, simultaneously with moving the first contact-and-move member 6a, the second contact-and-move member 6b, and the third contact-and-move member 6c in the rearward direction. Moving the end effector 1 at the time of positioning in this manner serves to suppress an external force to be exerted on the grape stem G by the first contact-and-move member 6a, the second contact-and-move member 6b, and the third contact-and-move member 6c.

In the embodiments described above, the end effector 1 allows the electric cylinder 3, as an actuator, to operate the target-object-positioning mechanism 4 and the processing mechanism 10. Alternatively, an actuator configured to reciprocate in the front-rear direction suffices. That is, the actuator of the end effector may be constituted by a combination of e.g., a motor, a belt, a chain, a gear, and a link. The actuator of the end effector is not limited to an electrically driven actuator, and may be a pneumatically or hydraulically driven actuator.

In the embodiments described above, the end effector 1 allows the electric cylinder 3, as a single actuator, to operate the target-object-positioning mechanism 4 and the processing mechanism 10. Alternatively, the end effector may allow respective independent actuators to operate the target-object-positioning mechanism 4 and the processing mechanism 10.

In the embodiments described above, the end effector is positioned at an arbitrary place by the work machine. As the work machine for moving the end effector, a work machine that moves the end effector at an arbitrary place suffices, such as a multi-joint robot arm, and a moving vehicle including an unmanned transport vehicle and an unmanned flight vehicle.

### REFERENCE SIGNS LIST

1, 1A, 1B end effector
2 support member
3 electric cylinder
4 target-object-positioning mechanism
5 coupling member
6 three-dimensional-contact-and-move mechanism
6a first contact-and-move member
6b second contact-and-move member
6c, 6d third contact-and-move member
7 opening-and-closing member
8 opening-and-closing-extendable-link mechanism (extendable link mechanism for opening and closing)
9 opening-and-closing-guide member (guide member for opening and closing)
10 processing mechanism
11 processing blade
12 processing-extendable-link mechanism (extendable link mechanism for processing)
13 processing guide member (guide member for processing)
14 stereo camera
15 first monocular camera
16 second monocular camera
G grape stem
R imaging area
P1 grabbing position
P2 processing position
Ta processing portion
D1 first orthogonal direction
D2 second orthogonal direction
D3 third orthogonal direction
S1 contact-and-move-member-moving space

1. An end effector configured to be movable by a work machine, for processing a target object at a processing position of the end effector, the end effector comprising:
a support member configured to be supported by the work machine;
a processing mechanism provided in the support member, for processing a portion of the target object at the processing position; and
a target-object-positioning mechanism provided at the support member, the target-object-positioning mechanism including a plurality of contact-and-move members configured to position the portion of the target object at the processing position, wherein
the plurality of contact-and-move members includes:
a first contact-and-move member configured to move in a front-rear direction of the end effector, and in a first orthogonal direction with respect to the support member, the front-rear direction including
a forward direction from the support member toward the processing position of the end effector, and
a rearward direction opposite to the forward direction,
the first orthogonal direction being orthogonal to the front-rear direction, and
a second contact-and-move member configured to move in the front-rear direction, and in a second orthogonal direction with respect to the support member, the second orthogonal direction being orthogonal to the front-rear direction and being different from the first orthogonal direction,
to thereby define a contact-and-move-member-moving space in which the plurality of contact-and-move members are movable and of which a cross-sectional area perpendicular to the front-rear direction increases in the forward direction,
the first contact-and-move member is configured to, while maintaining a position thereof in the front-rear direction with respect to the support member, move in the first orthogonal direction, to make contact with the target object in the contact-and-move-member-moving space,
the second contact-and-move member is configured to, while maintaining a position thereof in the front-rear direction with respect to the support member, move in the second orthogonal direction, to make contact with the target object in the contact-and-move-member-moving space, and
the first contact-and-move member and the second contact-and-move member are further configured to, while maintaining contact with the target object, move in the rearward direction with respect to the support member, to thereby position the portion of the target object at the processing position.

2. The end effector according to claim 1, wherein
the first contact-and-move member, the second contact-and-move member, and the processing mechanism are operated by a single actuator.

3. The end effector according to claim 1, wherein
the plurality of contact-and-move members further includes a third contact-and-move member, which is configured to move relative to the first contact-and-move member and the second contact-and-move member, in an approaching direction toward, and in a leaving direction from, the first contact-and-move member and the second contact-and-move member.

4. The end effector according to claim 3, wherein
the third contact-and-move member is fixed to the support member, or is movable with respect to the support member in the front-rear direction and in a third orthogonal direction, the third orthogonal direction being another direction orthogonal to the front-rear direction but different from the first orthogonal direction and the second orthogonal direction.

5. The end effector according to claim 3, wherein
the contact-and-move-member-moving space, when viewed in the front-rear direction, overlaps at least partially with the processing position.

6. The end effector according to claim 3, wherein
the contact-and-move-member-moving space, when viewed in the front-rear direction, overlaps at least partially with the support member.

7. The end effector according to claim 3, wherein
the first contact-and-move member has an end portion that is bent to be of a claw shape, moves in the front-rear direction with respect to the support member, and moves in the first orthogonal direction with respect to the support member,
the second contact-and-move member has an end portion that is bent to be of the claw shape, moves in the front-rear direction with respect to the support member, and moves in the second orthogonal direction with respect to the support member,
the third contact-and-move member has an end portion that is bent to be of the claw shape, moves in the front-rear direction with respect to the support member, and moves in a third orthogonal direction with respect to the support member, the third orthogonal direction being another direction orthogonal to the front-rear direction and being different from the first orthogonal direction and the second orthogonal direction, and
the first contact-and-move member, the second contact-and-move member, and the third contact-and-move member are moved by a single actuator.

8. The end effector according to claim 1, further comprising:
an imaging device that is provided on the support member, wherein
the plurality of contact-and-move members operate in an imaging area of the imaging device.
